(19) United States
(12) Patent Application Publication
(10) Pub. No.: US 2006/0166148 A1
(43) Pub. Date: Jul. 27, 2006

(54) Method of producing liquid developer and liquid developer produced by the method

(75) Inventors: Takashi Teshima, Nagano (JP); Koji Akioka, Nagano (JP)

Correspondence Address: HOGAN & HARTSON L.L.P., 500 S. GRAND AVENUE, SUITE 1900, LOS ANGELES, CA, 90071-2611, US

(73) Assignee: SEIKO EPSON CORPORATION

(21) Appl. No.: 11/316,368

(22) Filed: Dec. 21, 2005

(30) Foreign Application Priority Data
Dec. 21, 2004 (JP) 2004-370231
Dec. 21, 2004 (JP) 2004-370232

(51) Int. Cl. G03C 5/26

(52) U.S. Cl. 430/434

(57) ABSTRACT

A method of producing a liquid developer which comprises a high insulation solution and toner particles dispersed in the solution is provided. The method comprises the steps of: a kneading step for kneading a material containing a pigment and a resin material to obtain a kneaded material; a water-based emulsion preparing step for preparing a water-based emulsion, the water-based emulsion comprising a dispersoid composed of a material for the toner particles which has been prepared based on the kneading material and a water-based dispersion medium constituted from a water-based liquid in which the dispersoid is dispersed; a dispersion medium removal step for removing the dispersion medium to obtain dry fine particles; and a dispersing step for dispersing the dry fine particles into the high insulation liquid. According to the liquid developer producing method, it is possible to provide a liquid developer in which toner particles having a small particle size distribution and having a uniform shape are dispersed, and such a liquid developer can be produced with a method harmless to environment.

### BACKGROUND OF THE INVENTION

1. Field of the Invention

The present invention relates to a method of producing a liquid developer and a liquid developer produced by the method.

2. Description of the Prior Art

As a developer used for developing an electrostatic latent image formed on a latent image carrier, there are known two types. One type of such a developer is known as a dry toner which is formed of a material containing a coloring agent such as a pigment or the like and a binder resin, and such a dry toner is used in a dry condition thereof. The other type of such a developer is known as a liquid developer which is obtained by dispersing toner particles into a carrier liquid having electric insulation properties.

In the developing method using such a dry toner, since a solid state toner is used, there is an advantage in handleability thereof. On the other hand, however, this method involves problems in that contamination is likely to be caused by dispersal of toner powder and toner particles are likely to be massed together in a cartridge. Further, in such a dry toner, since aggregation of toner particles is likely to occur in the producing process thereof, it is difficult to obtain toner particles each having a sufficiently small diameter. This means that it is difficult to form a toner image having high resolution. Furthermore, there is also a problem in that when the size of the toner particle is made to be relatively small, the problems resulted from the powder form of the dry toner described above becomes more serious.

On the other hand, in the developing method using the liquid developer, since aggregation of toner particles in the liquid developer is effectively prevented, it is possible to use very fine toner particles and it is also possible to use a binder resin having a low softening point (a low softening temperature). As a result, the method using the liquid developer has the features such as good reproductivity of an image composed of thin lines, good tone reproductivity as well as good reproductivity of colors. Further, the method using the liquid developer is also superior as a method for forming an image at high speed.

Conventionally, such a liquid developer is produced by a grinding method in which toner particles are produced by grinding a resin (see JP-A No. 07-234551, for example) or a polymerization method in which monomer components are polymerized In a solution having electric insulation to produce resin particles which are not soluble in the electric insulation solution (see JP-B No. 08-7470, for example).

However, these conventional liquid developer producing methods accompany such problems as described below.

Namely, in the grinding method, since it is difficult to grind toner particles to a sufficiently small size (e.g. 5 μm or less), it takes very long time or it requires very large energy to obtain toner particles having a sufficiently small size that can exhibit properly the effects resulted by the use of the liquid developer as described above, thus leading to extremely low productivity of a liquid developer. Further, in the grinding method, a particle size distribution of toner particles is likely to be large (that is, there is large variations in particle size), and the shapes of the toner particles are liable to be irregular and nonuniform. As a result, obtained toner particles are likely to have variations in their properties among the toner particles.

Further, in the polymerization method, it is difficult to set polymerization conditions properly. This means that it is difficult to form toner particles having a desired size. Further, it is also difficult to make the variations in the size of the toner particles sufficiently small. As a result, stability of quality of a liquid developer and reliability thereof are likely to below. Further, since the polymerization method requires a relatively long time for the formation of the toner particles, the productivity of the liquid developer is not so high.

### SUMMARY OF THE PRESENT INVENTION

Accordingly, it is an object of the present invention to provide a liquid developer in which toner particles having a small particle size distribution are dispersed and a liquid developer producing method which can produce such a liquid developer. In particular, it is an object of the present invention to provide a liquid developer which contains toner particles having an uniform shape and a small particle size distribution and which can be produced by a method harmless to an environment.

In order to achieve the above mentioned object, the present invention is directed to a method of producing a liquid developer which comprises a high insulation liquid and toner particles dispersed in the high insulation liquid. The method comprises the steps of: a kneading step for kneading a material containing a pigment and a resin material to obtain a kneaded material; a water-based emulsion preparing step for preparing a water-based emulsion, the water-based emulsion comprising a dispersoid composed of a material for the toner particles which has been prepared based on the kneading material and a water-based dispersion medium constituted from a water-based liquid in which the dispersoid is dispersed; a dispersion medium removal step for removing the dispersion medium to obtain dry fine particles which are used as the toner particles: and a dispersing step for dispersing the dry fine particles into the high insulation liquid.

According to the liquid developer producing method described above, it is possible to produce effectively (with good productivity) a liquid developer in which toner particles having a small particle size distribution and having a uniform shape are dispersed. In particular, it is possible to provide a liquid developer producing method which makes it possible to produce a liquid developer in which toner particles having a small particle size distribution and having an uniform shape are dispersed a method harmless to environment.

In the liquid developer producing method according to the present invention, it is preferred that a self-dispersible type resin is used as the resin material.

By using such a self-dispersible type resin, it is possible to prepare a water-based dispersion liquid (including a water-based emulsion and a water-based suspension) in which a dispersoid constituted from the material for the toner particles are dispersed using an extremely small amount of a dispersant or without using any dispersant. Therefore, it is possible to effectively prevent occurrence of a problem resulted from the fact that the finally obtained liquid developer contains a dispersant. In more details, it is possible to effectively prevent a dispersant from giving an adverse effect to a charge property of toner particles. Further, it is also possible to prevent foam formation by a lowered antifoaming property resulted from the use of a dispersant for preparation of a dispersion liquid, thereby enabling to improve an ejection stability when the water-based dispersion liquid (water-based suspension) described later is ejected. Furthermore, since a dispersant or charge control agent is likely to be absorbed when resin particles constituted from the resin material for toner particles are dispersed into a high insulation liquid which constitutes a liquid developer, it is possible to further stabilize dispersion properties and charge properties. Moreover, since the functional groups of the self-dispersible type resin themselves have properties which are easily charged, use of such groups is advantageous in improving charge properties of toner particles themselves.

In this case, it is preferred that the self-dispersible type resin contains a hydrophilic group in its molecular.

Since such a self-dispersible type resin has an excellent dispersibility to a water-based liquid, it is possible to prepare a water-based dispersion liquid appropriately using an extremely small amount of a dispersant or without using any dispersant In the liquid developer producing method described above, it is preferred that the hydrophilic group is a —COO⁻ group or —SO₃⁻ group.

Since such s self-dispersible type resin has excellent dispersibilty to a water-based liquid and it can be manufactured relatively easily and available at a relatively low cost, it is possible to further reduce production cost of the liquid developer.

Further, the liquid developer producing method described above, it is preferred that the number of moles of the hydrophilic group contained in the self-dispersible type resin is 0.001 to 0.050 mol with respect to 100 g of the self-dispersible type resin.

This makes it possible to improve dispersibility of a dispersoid mainly constituted from the self-dispersible type resin while maintaining properties necessary for the toner particles more effectively.

Furthermore, in the liquid developer producing method according to the present invention, it is preferred that an average particle size of the dispersoid contained in the water-based emulsion is in the range of 0.01 to 5 μm.

This makes it possible to prevent bonding (aggregation) of the particles of the dispersoid in the water-based emulsion reliably, thereby enabling the size of finally obtained toner particles to be optimum size. In addition, it is also possible to obtain toner particles having sufficiently high roundness and uniformity in properties, size and shape of the respective particles (toner particles).

Furthermore, in the liquid developer producing method according to the present invention, it is preferred that the kneading step is carried out at a temperature equal to or higher than the softening temperature of the resin material.

This makes it possible to obtain toner particles in which the components thereof are homogeneously mixed, thereby enabling to make variations in their properties such as chargeable characteristic and the like small.

Furthermore, in the liquid developer producing method according to the present invention, it Is preferred that the water-based emulsion is prepared using a solution obtained by dissolving at least a part of the kneaded material into a solvent which can dissolve the kneaded material.

According to this method, it is possible to make variations in shape and size of the toner particles small, and thus variations in properties (such as chargeable characteristic) of the toner particles can be made small. Further, it is also possible to make the diameter of each toner particle smaller.

Moreover, in the liquid developer producing method according to the present invention, it is preferred that in the water-based dispersion medium removal step, a water-based suspension obtained by removing the solvent from the water-based emulsion is used.

This makes to possible to prevent undesirable aggregate of the particles in the water-based dispersion medium removal step more effectively, and as a result thereof, the uniformity in the shape and size of the toner particles can be made especially excellent. Further, deairing treatment can be performed together with the removal of the solvent, it is possible to prevent formation of dry fine particles (toner particles) having different shapes effectively even in the case where the dry fine particles are obtained in the form of aggregation of a plurality of particles of the dispersoid.

Moreover, in the liquid developer producing method according to the present invention, it is preferred that a water-based suspension obtained by dispersing a solid state dispersoid into the water-based dispersion medium is prepared using the water-based emulsion, and then thus prepared water-based emulsion is used in the water-based dispersion medium removal step.

This also makes it possible to prevent undesirable aggregation of the particles in the water-based dispersion medium removal step more effectively. As a result, it is possible to obtain toner particles having the excellent uniformity in size and shape thereof.

Moreover, in the liquid developer producing method according to the present invention, it is preferred that an average particle size of the dispersoid contained in the water-based suspension is in the range of 0.01 to 5 μm.

This makes it possible to obtain toner particles having sufficiently high roundness and uniformity in properties, size and shape of the respective particles (toner particles). Further, it is also possible to raise the resolution of an image formed using the liquid developer to an extremely high level.

Another aspect of the present invention is directed to a liquid developer produced using the liquid developer producing method as described above.

This liquid developer has toner particles dispersed therein and such toner particles have a uniform shape and small particle size distribution.

In the liquid developer according to the present invention, it is preferred that an average particle size of toner particles is in the range of 0.1 to 5 μm.

This makes it possible to make variations in properties of the toner particles such as chargeable characteristic and fixing properties, and therefore the reliability of the liquid developer as a whole can be made especially high, and the resolution of an image to be formed using the liquid developer (liquid toner) can be also made especially high.

Further, in the liquid developer according to the present invention, it is preferred that the standard deviation in the particle size among the toner particles is 3.0 μm or less.

This makes it possible to make variations in properties such as chargeable characteristic and fixing properties particularly small, thereby enabling to improve reliability of the liquid developer as a whole.

Furthermore, in the liquid developer according to the present invention, it is preferred that an average value of the roundness R (average sphericity) of the toner particles represented by the following formula (I) is 0.85 or more:
R=L₀/L₁ (I)

whrein L₁ (μm) represents the circumference of a projected image of a toner particle, and L₀ (μm) represents the circumference of a perfect circle (a geometrically perfect circle) having the same area as that of the projected image of the toner particle.

This makes it possible to make the size of each toner particle sufficiently small, and therefore the toner particles can have excellent transfer efficiency and mechanical strength.

Moreover, in the liquid developer according to the present invention, it is preferred that the standard deviation in the average roundness of the toner particles is 0.15 or less.

This also makes it possible to make variations in properties such as chargeable characteristic and fixing properties particularly small, thereby enabling to improve reliability of the liquid developer as a whole.

These and other objects, structures and effects of the present invention will be more apparent when the following detailed description of the preferred embodiments and the examples will be considered taken in conjunction with the appended drawings.

### BRIEF DESCRIPTION OF THE DRAWINGS

FIG. 1 is a vertical cross-sectional view which schematically shows one example of the structure of a kneading machine and a cooling machine both used for producing a kneaded material used for preparing a water-based emulsion.

FIG. 2 is a vertical cross-sectional view which schematically shows a preferred embodiment of a dry fine particle producing apparatus (an apparatus for producing toner particles) used in producing a liquid developer according to the present invention.

FIG. 3 is an enlarged sectional view of a head portion of the dry fine particle producing apparatus shown in FIG. 2.

FIG. 4 is a cross-sectional view of one example of a contact type image forming apparatus to which the liquid developer of the present invention can be applied.

FIG. 5 is a cross sectional view of one example of a non-contact type image forming apparatus to which the liquid developer of the present invention can be applied.

FIG. 6 is a cross-sectional view which shows one example of a fixing apparatus to which the liquid developer of the present invention can be applied.

FIG. 7 is an illustration which schematically shows another example of the structure in the vicinity of the head portion of the dry fine particle producing apparatus of the present invention.

FIG. 8 is an illustration which schematically shows other example of the structure in the vicinity of the head portion of the dry fine particle producing apparatus of the present invention.

FIG. 9 is an illustration which schematically shows the other example of the structure in the vicinity of the head portion of the dry fine particle producing apparatus of the present invention.

FIG. 10 is an illustration which schematically shows yet other example of the structure in the vicinity of the head portion of the dry fine particle producing apparatus of the present invention.

### DETAILED DESCRIPTION OF THE PREFERRED EMBODIMENTS

Hereinbelow, with reference to the accompanying drawings, a preferred embodiment of a method of producing a liquid developer according to the present invention and a liquid developer manufactured by the method will be described in details.

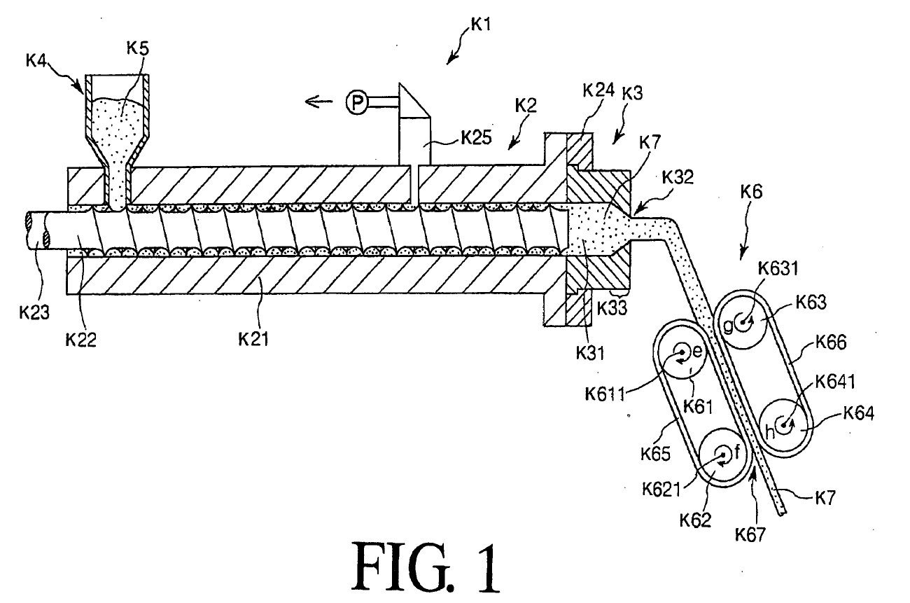

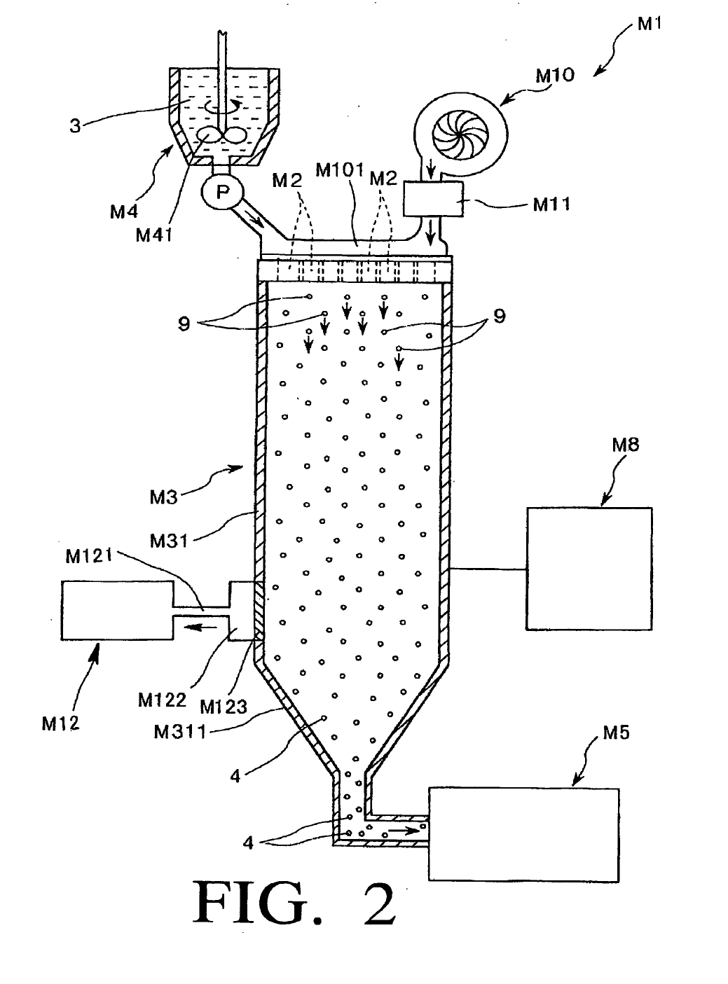

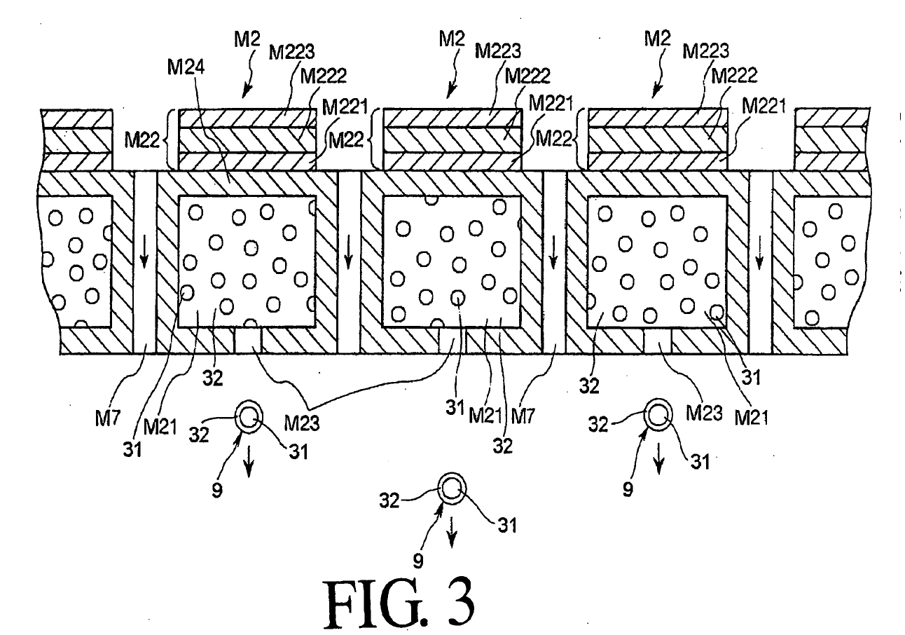

FIG. 1 is a vertical cross-sectional view which schematically shows one example of the structure of a kneading machine and a cooling machine both used for producing a kneaded material used for preparing a water-based emulsion, FIG. 2 is a vertical cross-sectional view which schematically shows a preferred embodiment of a dry fine particle producing apparatus (an apparatus for producing toner particles) used in producing a liquid developer according to the present invention, and FIG. 3 is an enlarged sectional view of a head portion of the dry fine particle producing apparatus shown in FIG. 2. In the following description, the left side in FIG. 1 denotes “base” or “base side” and the right side in FIG. 1 denotes “front” or “front side”.

The liquid developer producing method according to the present invention is characterized by comprising:

a kneading step for kneading a material containing a pigment and a resin material to obtain a kneaded material;

a water-based emulsion preparing step for preparing a water-based emulsion using the kneaded material, the water-based emulsion comprising a dispersoid composed of a material of toner particles and a water-based dispersion medium constituted from a water-based liquid in which the dispersoid is dispersed;

a dispersion medium removal step for removing the dispersion medium to obtain dry fine particles which are used as the toner particles; and

a dispersing step for dispersing the dry fine particles into the high insulation liquid.

<Constituent Material of Kneaded Material>

A kneaded material obtained in the kneading step described below contains a component which forms a toner particle of a liquid developer, and the kneaded material contains at least a binder resin (resin material) and a coloring agent.

First, a description will be made with regard to a constituent material used for preparing the kneaded material.

1. Resin (Binder Resin)

Generally, toner particles contained in a liquid developer are constituted from a material which contains a resin (binder resin) as its main component.

In the present invention, there is no specific limitation on the kinds of resin (binder resin) to be used. Examples of such resins (binder resins) include (meth)acrylic-based resins, polycarbonate resins, styrene-based resins (homopolymers or copolymers containing styrene or a styrene substituent) such as polystyrene, poly-α-methylstyrene, chloropolystyrene, styrene-chlorostyrene copolymer, styrene-propylene copolymer, styrene-butadiene copolymer, styrene-vinyl chloride copolymer, styrene-vinyl acetate copolymer, styrene-maleic acid copolymer, styrene-acrylic ester copolymer, styrene-methacrylic ester copolymer, styrene-acrylic ester-methacrylic ester copolymer, styrene-α-methyl chloroacrylate copolymer, styrene-acrylonitrile-acrylic ester copolymer, and styrene-vinyl methyl ether copolymer. polyester-based resins, epoxy resins, urethane-modified epoxy resins, silicone-modified epoxy resins, vinyl chloride resins, rosin-modified maleic acid resins, phenyl resins, polyethylene-based resins, polypropylene, ionomer resins, polyurethane resins, silicone resins, ketone resins, ethylene-ethylacrylate copolymer, xylene reins, polyvinyl butyral resins, terpene reins, phenol resins, and aliphatic or alicyclic hydrocarbon resins. These binder resins can be used singly or in combination of two or more of them.

In the present invention, as a resin material constituting the kneaded material, a self-dispersible type resin which has dispersibility to a water-based liquid described later may be used. In this regard, it is to be noted that in this specification, the term “self-dispersible” means properties having dispersibility to a dispersion medium without using a dispersant, and the term “self-dispersible type resin” means a resin material having such self-dispersibility. No particular limitation is imposed on the self-dispersible type resin, and examples of such a self-dispersible type resin include a resin having a plurality of groups which are lyophilic (hydrophilic) to a water-based liquid described below.

Examples of groups (functional groups) having such lyophilic property (hydrophilic property) include —COO⁻ group, —SO₃⁻ group, —CO group, —OH group, —OSO₃⁻ group, —COO-group, —SO3—, —OSO₃-group, —PO₃H₂, —PO₄-group, and quaternary ammonium, and salts thereof. Since such a self-dispersible type resin has excellent dispersibilty to a water-based liquid, it is possible to prepare a water-based dispersion liquid (water-based emulsion and water-based suspension) described later without using any dispersant or by using an extremely small amount of dispersant. As a result, it is possible to prevent effectively occurrence of a problem resulted from the fact that a dispersant is contained in a liquid developer finally obtained. In more details, it is possible to effectively prevent a dispersant from giving an adverse effect to a charge property of toner particles. Further, it is also possible to prevent foam formation by a lowered antifoaming property resulted from the use of a dispersant for preparation of a dispersion liquid, thereby enabling to improve an ejection stability when the water-based dispersion liquid (water-based suspension) described later is ejected. Furthermore, since a dispersant or charge control agent are likely to be absorbed when resin particles are dispersed in to a carrier solution which constitutes a liquid developer, it is possible to further stabilize dispersion properties and charge properties.

The groups mentioned above themselves have properties which are easily charged. Therefore, use of such groups is advantageous in improving charge properties of toner particles themselves.

Further, among the groups mentioned above, —COO-group and —SO₃-gourp are particularly preferred. A self-dispersible type resin having such a group has particularly superior dispersion properties against the water-based liquid and it can be manufactured relatively easily and be available at a relatively low cost. As a result, it is possible to further reduce production cost of the liquid developer.

It is preferred that the group mentioned above exists at a side chain of a polymer constituting a resin material. This makes it possible to make hydrophilic property against the water-based liquid more excellent, and thereby to make dispersibility of a dispersant constituted from a self-dispersible type resin in a water-based liquid (water-based emulsion and water-based suspension) especially excellent. Furthermore, it is also possible to manufacture a liquid developer by a method which is harmless to environment since it does not use any polar organic solvents.

The self-dispersible type resin described above can be manufactured by bonding the material having the functional group described above to a raw resin material (raw resin) or its monomer, dimer, oligomer, and the like.

For example, a self-dispersible type resin having —COO-group can be manufactured by graft copolymerization or block-copolymerization of a low water-soluble or water-insoluble resin (raw resin) with unsaturated carboxylic acids, or random copolymerization of a monomer constituting a thermoplastic resin with unsaturated carboxylic acids.

Example of such unsaturated carboxylic acids include unsaturated monocarboxylic acids, dicarboxylic acid or anhydrides thereof such as (meth)acrylic acid, maleic acid, fumaric acid, tetrahydrophthalic acid, itaconic acid, citraconic acid, crotonic acid, isocrotonic acid, nagic acid, maleic anhydride, citraconic anhydride; ester compounds such as monoester and diester of methyl, ethyl, and propyl of the unsaturated carboxylic acids; salts of unsaturated carboxylic acids such as alkali metal salts, alkaline earth metal salts, ammonium salts, and the like.

Further, the self-dispersible type resin having —SO₃-group can be manufactured by, for example, graft copolymerization or block-copolymerization of a thermoplastic resin (raw resin) with unsaturated sulfonic acids, random copolymerization of an unsaturated monomer constituting an addition polymerization type thermoplastic resin with a monomer containing unsaturated sulfonic acids, or polycondensation of a monomer constituting a polycondensation type thermoplastic resin with a monoer containing unsaturated sulfonic acids.

Examples of such sulfonic acids include styrene sulfonic acids, sulfoalkkyl(meth)acrylate, metal salts thereof, and ammonium salts, and the like. Further, examples of a monomer containing sulfone acids include sulufo-isophthalic acid, sulufo-terephthalic acid, sulfo-phthalic acid, sulfo-siccomoc acid, sulfo-benzoic acid, sulfo-salicylic acid, and metal salts thereof, and ammonium salts, and the like.

Examples of a resin (raw resin) which can be used as a constituent material of the self-dispersible type resin include (meth)acrylic resin; polycarbonate resin; a monomer or a copolymer of styrene resin that includes styrene or a styrene substitution product, such as polystyrene, poly-α-methylstyrene, chloropolystyrene, styrene-chlorostyrene copolymer, styrene-propylene copolymer, styrene-butadlene copolymer, styrene-vinyl chloride copolymer, styrene-vinyl acetate copolymer, styrene-maleic acid copolymer, styrene-acrylate ester copolymer, styrene-methacrylate ester copolymer, styrene-acrylate ester-methacrylate ester copolymer, styrene-α-methyl chloroacrylate copolymer, styrene-acrylonitrile-acrylate ester copolymer, styrene-vinylmethylether copolymer, or the like; polyester resin (which is different from the above-desoribed block polyester and amorphous polyester); epoxy resin; urethane modified epoxy resin; silicone modified epoxy resin; vinyl chloride resin; rosin modified maleic acid resin; phenyl resin; polyethylene-based resin; polypropylene; ionomer resin; polyurethane resin; silicone resin; ketone resin; ethylene-ethyl acrylate copolymer; xylene resin; polyvinyl butyral resin; terpene resin; phenol resin; aliphatia or alicyclic hydrocarbon resin; or the like can be mentioned. These resin components can be used alone or in combination of two or more.

As described above, the self-dispersible type resin can be manufactured by polymerizing a precursor having a functional group described above (that is, corresponding monomer, dimmer, oligomer, and the like).

The number of the functional groups (hydrophilic groups) contained in the self-dispersible type resin is preferably in the range of 0.001 to 0.050 mol with respect to 100 g of the self-dispersible type resin, and more preferably in the range of 0.005 to 0.030 mol. This makes it possible to improve dispersibility of the dispersoid mainly formed of the self-dispersible type resin while maintaining effectively properties necessary as a toner particle.

The content of the self-dispersible type resin in the kneaded material (that is, the content of the self-dispersible type resin in the composition used for preparing the kneaded material) is not limited to any specific value, but it is preferably in the range of 55 to 95 wt %, more preferably in the range of 60 to 90 wt %, and even more preferably in the range of 65 to 85 wt %. If the content of the self-dispersible type resin is less than the above lower limit value, there is a case that it is not possible to raise the dispersibility of the dispersant in the water-based dispersion liquid (water-based emulsion and water-based suspension) sufficiently. On the other hand, if the content of the self-dispersible type resin exceeds the above upper limit value, the amount of the coloring agent is relatively decreased so that it becomes difficult to form a visible image having a sufficient contrast when a resultant liquid developer is actually used.

The kneaded material may contain other resin materials in addition to the self-dispersible type resin described above. As for such resin materials (that is, resin materials other than the self-dispersible type resin), resin materials such as those mentioned above as the raw material resins. Further, in the present invention, resin materials without self-dispersibility may be used as described above.

The softening point of the resin (resin material) is not limited to any specific value, but it is preferably in the range of 50 to 130° C., more preferably in the range of 50 to 120° C., still more preferably in the range of 60 to 115° C., and most preferably in the range of 65 to 115° C. In this specification, the term “softening point” means a temperature at which softening is begun under the conditions that a temperature raising speed is 5° C./mim and a diameter of a die hole is 1.0 mm in a high-floored flow tester. Further, in the case where the resin material contains two ore more types of resins, the softening point of the resin material is determined by the weight average of these resins.

2. Coloring Agent

A toner includes a coloring agent. As for a coloring agent, pigments, dyes or the like can be used. Examples of such pigments and dyes include Carbon Black, Spirit Black, Lamp Black (C.I. No. 77266), Magnetite, Titanium Black, Chrome Yellow, Cadmium Yellow, Mineral Fast Yellow, Navel Yellow, Naphthol Yellow S, Hansa Yellow G, Permanent Yellow NCG, Benzidine Yellow, Quinoline Yellow, Tartrazine Lake, Chrome Orange, Molybdenum Orange, Permanent Orange GTR, Pyrazolone Orange, Benzidine Orange G, Cadmium Red, Permanent Red 4R, Watching Red Calcium Salt, Eosine Lake, Brilliant Carmine 3B, Manganese Violet, Fast Violet B, MethylViolet Lake, PrussianBlue, Cobalt Blue, Alkali Blue Lake, Victoria Blue Lake, Fast Sky Blue, Indanthrene Blue BC, Ultramarine Blue, Aniline Blue, Phthalocyanine Blue, Chalco Oil Blue, Chrome Green, Chromium Oxide, Pigment Green B, Malachite Green Lake, Phthalocyanine Green, Final Yellow Green G, Rhodamine 6G, Quinacridone, Rose Bengal (C.I. No. 45432), C.I. Direct Red 1, C.I. Direct Red 4. C.I. Acid Red 1, C.I. Basic Red 1, C.I. Mordant Red 30, C.I. Pigment Red 48:1, C.I. Pigment Red 57:1, C.I. Pigment Red 122, C.I. Pigment Red 184, C.I. Direct Blue 1, C.I. Direct Blue 2, C.I. Acid Blue 9, C.I. Acid Blue 15, C.I. Basic Blue 3, C.I. Basic Blue 5, C.I. Mordant Blue 7, C.I. Pigment Blue 15:1, C.I. Pigment Blue 15:3, C.I. Pigment Blue 5:1, C.I. Direct Green 6, C.I. Basic Green 4, C.I. Basic Green 6, C.I. Pigment Yellow 17, C.I. Pigment Yellow 93, C.I. Pigment Yellow 97, C.I. Pigment Yellow 12, C.I. Pigment Yellow 180, C.I. Pigment Yellow 162, and Nigrosine Dye (C.I. No. 50415B); metal oxides such as metal complex dyes, silica, aluminum oxide, magnetite, maghemite, various kinds of ferrites, cupric oxide, nickel oxide, zinc oxide, zirconium oxide, titanium oxide, magnesium oxide, and the like; and magnetic materials including magnetic metals such as Fe, Co, and Ni; and the like. These pigments and dyes can be used singly or in combination of two or more of them.

3. Other Components

In preparing the kneaded material, additional components other than the above components may be contained. Examples of such other components include a wax, a charge control agent, a magnetic powder, and the like.

Examples of such a wax include hydrocarbon wax such as ozokerite, ceresin, paraffin wax, micro wax, microcrystalline wax, petrolatum, Fischer-Tropsch wax, or the like; ester wax such as carnauba wax, rice wax, methyl laurate, methyl myristate, methyl palmitate, methyl stearate, butyl stearate, candelilla wax, cotton wax, Japan wax, beeswax, lanolin, montan wax, fatty ester, or the like; olefin wax such as polyethylene wax, polypropylene wax, oxidized polyethylene wax, oxidized polypropylene wax, or the like; amide wax such as 12-hydroxystearic acid amide, stearic acid amide, phthalic anhydride imide, or the like; ketone wax such as laurone, stearone, or the like; ether wax; and the like. These waxes can be used singly or in combination of two or more.

Examples of the charge control agent include a metallic salt of benzoic acid, a metallic salt of salicylic acid, a metallic salt of alkylsalicylic acid, a metallic salt of catechol, a metal-containing bisazo dye, a nigrosine dye, tetraphenyl borate derivatives, a quaternary ammonium salt, an alkylpyridinium salt, chlorinated polyester, nitrohumic acid, and the like.

Further, examples of the magnetic powder include a powder made of a magnetic material containing a metal oxide such as magnetite, maghemite, various kinds of ferrites, cupric oxide, nickel oxide, zinc oxide, zirconium oxide, titanium oxide, magnesium oxide, or the like, and/or magnetic metal such as Fe, Co or Ni.

Further, the constituent material of the kneaded material may further contain zinc stearate, zinc oxide, cerium oxide, silica, titanium oxide, iron oxide, aliphatic acid, or aliphatic metal salt, or the like in addition to the materials described above.

Furthermore, the constituent material of the kneaded material may further contain materials used as a solvent such as inorganic solvent, organic solvent and the like. This makes it possible to improve kneading efficiency so that the kneaded material in which each component thereof is mixed with each other more homogeneously can be obtained.

<Kneaded Material>

Hereinbelow, a description will be made with regard to one example of a method for obtaining a kneaded material K7 by kneading a material K5 which contains the above-mentioned components.

The kneaded material K7 can be manufactured using a kneading apparatus as shown in FIG. 1.

<Kneading Step>

The material K5 to be kneaded contains the components as described above. By containing a coloring agent, air such as air contained by the coloring agent is also contained in the material K5, which means that there is a possibility that air bubble could enter the inside of the toner particle. However, since the material K5 is subjected to the kneading process in this step, it is possible to eliminate air contained in the material K5 efficiently, and therefore it is possible to prevent air bubble from entering the inside of the toner particle effectively, that is, prevent air bubble from remaining inside the toner particle effectively. Therefore, it is preferred that the material K5 to be kneaded is prepared in advance by mixing the above-mentioned various components.

In this embodiment, a biaxial kneader-extruder is used as the kneading machine, a detail of which will be described below.

The kneading machine K1 Includes a process section K2 which kneads the material K5 while conveying it, a head section K3 which extrudes a kneaded material K7 so that an extruded kneaded material can have a prescribed cross-sectional shape, and a feeder K4 which supplies the material K5 into the process section K2.

The process section K2 has a barrel K21, screws K22 and K23 inserted into the barrel 21, and a fixing member K24 for fixing the head section K3 to the front portion of the barrel K21.

In the process section K2, a shearing force is applied to the material K5 supplied from the feeder K4 by the rotation of the screws K22 and K23 so that a homogeneous kneaded material K7 is obtained.

In this embodiment, it is preferred that the total length of the process section K2 is in the range of 50 to 300 cm, and more preferably in the range of 100 to 250 cm. If the total length of the process section K2 is less than the above lower limit value, there is a case that it is difficult to mix and knead the components in the material K5 homogeneously. On the other hand, if the total length of the process section K2 exceeds the above upper limit value, there is a case that thermal modification of the material K5 is likely to occur depending on the temperature inside the process section K2, or the number of revolutions of the screws K22 and K23, or the like, thus leading to a possibility that it becomes difficult to control the physical properties of a finally obtained liquid developer (that is, resultant liquid toner) sufficiently.

In this connection, when the temperature of the material (material temperature) during the kneading step is preferably in the range of 80 to 260° C., and more preferably in the range of 90 to 230° C. though it varies depending on the composition of the material K5 and the like. In this regard, it is to be noted that the temperature of the material inside the process section K2 may be constant throughout the process section K2 or different depending on positions inside the process section K2. For example, the process section K2 may include a first region in which an internal temperature is set to be relatively low, and a second region which is provided at the base side of the first region and in which an internal temperature is set to be higher than the internal temperature of the first region.

Moreover, it is preferred that the residence time of the material K5 in the process section K2, that is the time required to pass through the process section K2, is 0.5 to 12 minutes, and more preferably 1 to 7 minutes. If the residence time of the material K5 in the process section K2 is less than the above lower limit value, there is a possibility that it is difficult to mix the components in the material K5 homogeneously. On the other hand, if the residence time of the material K5 in the process section K2 exceeds the above upper limit value, there is a possibility that production efficiency is lowered, and thermal modification of the material K5 is likely to occur depending on the temperature inside the process section 2 or the number of revolutions of the screws K22 and K23, or the like, thus resulting in a case that it is difficult to control the physical properties of a finally obtained liquid developer (that is, a resultant liquid toner) satisfactorily.

Although the number of revolutions of the screws K22 and K23 varies depending on the compositions of the binder resin or the like, 50 to 600 rpm is preferable. If the number of revolutions of the screws K22 and K23 is less than the above lower limit value, there is a case that it is difficult to mix the components of the material K5 homogeneously. On the other hand, if the number of revolutions of the screws K22 and K23 exceeds the above upper limit value, there is a case that molecular chains of the resin are cut due to a shearing force, thus resulting in the deterioration of the characteristics of the resin.

In the kneading machine K1 used in this embodiment, the inside of the process section K2 is connected to a pump P through a duct K25. This makes it possible to deaerate the inside of the process section K2, thereby enabling to prevent the pressure inside the process section K2 from raising due to heated-up or heat generation of the material K5 (kneaded material K7). As a result, the kneading step can be carried safely and effectively. Further, since the inside of the process section K2 is connected to the pump P through the duct K25, it is possible to prevent air bubble (in particular, relatively large air bubble) from being contained effectively, so that it becomes possible to obtain a liquid developer (that is, a liquid toner) having excellent properties.

<Extrusion Process>

The kneaded material K7 which has been kneaded in the process section K2 is extruded to the outside of the kneading machine K1 via the head section K3 by the rotation of the screws K22 and K23.

The head section K3 has an Internal space K31 to which the kneaded material K7 is sent from the process section K2, and an extrusion port K32 through which the kneaded material K7 is extruded.

In this connection, it is preferred that the temperature (temperature at least in the vicinity of the extrusion port K32) of the kneaded material K7 in the internal space K31 is higher than a softening temperature of the resin materials contained in the material K5. When the temperature of the kneaded material K7 is such a temperature, it is possible to obtain a toner particle in which the components thereof are homogeneously mixed, thereby enabling to make variations in its properties such as chargeable characteristic, fixing properties, and the like small.

The concrete temperature of the kneaded material K7 inside the internal space K31 (that is, the temperature of the kneaded material K7 at least in the vicinity of the extrusion port K32) is not limited to a specific temperature, but is preferably in the range of 80 to 150° C., and more preferably in the range of 90 to 140° C. In the case where the temperature of the kneaded material K7 in the internal space K31 is within the above range, the kneaded material K7 is not solidified inside the internal space K31 so that it can be extruded from the extrusion port 32K easily.

The internal space K31 having a structure as shown in FIG. 1 includes a cross sectional area reduced portion K33 in which a cross sectional area thereof is gradually reduced toward the extrusion port K32. Due to the cross sectional area reduced portion K33, the extrusion amount of the kneaded material K7 which is to be extruded from the extrusion port 32K becomes stable, and the cooling rate of the kneaded material K7 in a cooling process which will be described later also becomes stable. As a result of this, variations in properties of each toner particle can be made small, whereby enabling to obtain a liquid developer (that is, a liquid toner) having excellent properties.

<Cooling Process>

The kneaded material K7 in a softened state extruded from the extrusion port K32 of the head section 3 is cooled by a cooler K6 and thereby it is solidified.

The cooler K6 has rolls K61, K62, K63 and K64, and belts K65 and K66.

The belt K65 is wound around the rolls K61 and K62, and similarly, the belt 66 is wound around the rolls K63 and K64.

The rolls K61, K62, K63 and K64 rotate in directions shown by the arrows e, f, g and h in the drawing about rotary shafts K611, K621, K631 and K641, respectively. With this arrangement, the kneaded material K7 extruded from the extrusion port K32 of the kneading machine K1 is introduced into the space between the belts K65 and K66. The kneaded material K7 is then cooled while being molded into a plate-like object with a nearly uniform thickness, and is ejected from an ejection part K67. The belts K65 and K66 are cooled by, for example, an air cooling or water cooling method. By using such a belt type cooler, it is possible to extend a contact time between the kneaded material extruded from the kneading machine and the cooling members (belts), thereby enabling the cooling efficiency for the kneaded material to be especially excellent.

Now, during the kneading process, since the material K5 is subjected to a shearing force, phase separation (in particular, macro-phase separation) can be prevented. However, since the kneaded material K7 which went through the kneading process is free from the shearing force, there is a possibility that phase separation (in particular, macro-phase separation) will occur again if such a kneaded material is being left standing for a long period of time. Accordingly, it is preferable to cool the thus obtained kneaded material K7 as quickly as possible. More specifically, it is preferred that the cooling rate (for example, the cooling rate when the kneaded material K7 is cooled down to about 60° C.) of the kneaded material K7 is faster than −3° C./s, and more preferably in the range of −5 to −100° C./s. Moreover, the time between the completion of the kneading process (at which a shearing force has eliminated) and the completion of the cooling process (time required to decrease the temperature of the kneaded material K7 to 60° C. or lower, for example) is preferably 20 seconds or less, and more preferably 3 to 12 seconds.

In the above embodiment, a description has been made in terms of an example using a continuous biaxial kneader-extruder as the kneading machine, but the kneading machine used for kneading the material is not limited to this type. For kneading the material, it is possible to use various kinds of kneading machines, for example, a kneader, a batch type triaxial roll, a continuous biaxial roll, a wheel mixer, a blade mixer, or the like.

Further, although in the embodiment shown in the drawing the kneading machine is of the type that has two screws, the number of screws may be one or three or more. Further, the kneading machine may have a disc section (kneading disc section).

Furthermore, in the embodiment described above, one kneading machine is used for kneading the material, but kneading may be carried out by using two kneading machines. In this case, the heating temperature of the material and the rotational speed of the screws of one kneading machine may be different from those of the other kneading machine.

Moreover, in the above embodiment, the belt type cooler is used, but a roll type (cooling roll type) cooler may be used. Furthermore, cooling of the kneaded material extruded from the extrusion port K32 of the kneading machine is not limited to the way using the cooler described above, and it may be carried out by air cooling, for example.

<Grinding Process>The kneaded material K7 obtained through the cooling process described above is ground. By grinding the kneaded material K7, it is possible to obtain a water-based emulsion (described later) in which a fine dispersants is dispersed relatively easily. As a result, it becomes possible to make the size of the toner particles smaller in a liquid developer finally obtained, and such a liquid developer can be preferably used in forming a high resolution image.

The method of grinding is not particularly limited. For example, such grinding may be carried out by employing various kinds of grinding machines or crushing machines such as a ball mill, a vibration mill, a jet mill, a pin mill, or the like.

The grinding process may be carried out by dividing it into a plurality of stages (for example, two stages of coarse and fine grinding processes). Further, after the grinding process, other treatment such as classification treatment may be carried out as needed. Such classification treatment may be carried out using a sieve or an air flow type classifier or the like.

By subjecting the material K5 to the kneading process as described above, it is possible to eliminate air contained in the material K5 effectively. In other words, the kneaded material K7 obtained through such a kneading process does not contain air (air bubble) in the inside thereof. By using such kneaded material K7, it is possible to prevent generation of toner particles of irregular shape (such as void particles, defect particles, fused particles, and the like) effectively. As a result, in a liquid developer finally obtained,.it is possible to prevent occurrence of a problem such as lowered transfer property and cleaning property which are caused by such toner particles having irregular shape.

In the present invention, a water-based emulsion is prepared using the kneaded material described above.

By using the kneaded material K7 in preparing the water-based emulsion, the following effects can be obtained. Namely, even in the case where a constituent material of toner particles contains components which are difficult to be dispersed in a dispersion medium or difficult to be mutually soluble to each other, these components are mutually soluble to each other satisfactorily and finely dispersed in an obtained kneaded material by way of the kneading step described above. In particular, most of pigments (coloring agent) have poor dispersibility to a liquid used as a solvent. However, in this embodiment, because the kneading step has been carried out before the kneaded material is dispersed into a solvent, the outer periphery of each particle of a pigment is coated with a resin component effectively. Therefore, dispersibility of the pigment to the solvent is improved (particularly, the pigment can be finely dispersed in the solvent), color development of a finally obtained liquid developer becomes excellent. For these reasons, even in the case where a constituent material of toner particles contains a component having poor dispersibility to a dispersion medium of a water base-emulsion (water-based solvent) which will be described later (hereinafter, this component will be referred to as “poor dispersibility component”) or a component having poor solubility to a solvent contained in a dispersion medium of a water-based emulsion (hereinafter, this component will be referred to as “poor solubility component”), it is possible to make dispersibility of a dispersoid in a water-based emulsion more excellent. Further, in a water-based suspension 3 (droplets 9), dispersibility of a dispersoid 31 becomes excellent. With these results, in a finally obtained liquid developer, variations in compositions and properties of respective toner particles can be made small, and therefore the liquid developer can have excellent properties as a whole.

On the other hand, in the case where a material which has not been kneaded is used in preparing a water-based emulsion, a poor dispersibility component and/or a poor solubility component are aggregated and then the aggregates thereof settle down in a water-based emulsion or a water-based suspension described later. As a result, a dispersoid comprised of relatively large particles which are mainly constituted from the poor dispersibility component and/or poor solubility component and which have not been sufficiently mixed with other components exist in the water based-emulsion (and the water based suspension). That is, a dispersoid comprised of large particles which are mainly constituted from the poor dispersibility component and/or poor solubility component and a dispersoid comprised of particles constituted from components other than the poor dispersibility component or poor solubility component exist in a water-based emulsion and/or a water-based suspension in a mixed state. Accordingly, dry fine particles (that is, toner particles) obtained in the water-based dispersion medium removal step described later are apt to have large variations in compositions, size and shape of the respective toner particles. As a result, properties of a liquid developer obtained are lowered as a whole.

Further, in the case where particles obtained by grinding the kneaded material are used as toner particles as they are without being used in preparing a water-based emulsion as described later, there is a limit on raising homogeneity (uniformity) of the components in the toner particles. Further, according to this method, it is particularly difficult to disperse or finely disperse a pigment which is generally in the form of relatively ridged aggregates (which is likely to be in the form of ridged aggregates).

In contrast, according to the present invention, since the kneaded material described above is used in preparing a water-based emulsion, it is possible to obtain toner particles in which the respective components are dispersed (finely dispersed) or mutually dissolved sufficiently homogeneously.

Further, in the water-based emulsion used in the present invention, a dispersoid is in a liquid sate (that is, a dispersoid has fluidity so that it can be deformed relatively easily), there is a tendency that each dispersoid is formed into a shape having a relatively high roundness (sphericity) due to its surface tension. Accordingly, in a suspension (water-based suspension) prepared using the water-based emulsion, there is also a tendency that each dispersoid is formed into a shape having a relatively high roundness (sphericity). Further, in the emulsion containing a dispersoid in a liquid state (that is, a dispersoid having fluidity so that it can be deformed relatively easily), it is possible to raise uniformity in the size of the dispersoid relatively easily by stirring the emulsion. In contrast, in the case where resin particles which are prepared without the water-based emulsion process are used in a suspension which is used for producing dry particles described later, a dispersoid contained in the suspension is likely to have low roundness, so that variations in the shape or particle size (diameter) of the respective particles become larger. In this connection, in order to suppress such variations in their shape, it may be conceived that a heat spheronization treatment is carried out when dry fine particles are being formed or after dry fine particles have been formed. However, in such a case (particularly, when such a heat spheronization treatment is carried out when dry fine particles are being formed), it is difficult to make the variations in shapes of the obtained particles sufficiently small unless otherwise conditions for the heat spheronization treatment are set to be relatively severe. Further, such severe conditions for the heat spheronization treatment in turn involves such problems in that deterioration of the constituent material of the dry fine particles is likely to occur and a mutually dissolved state and a finely dispersed state of the components in the respective dry fine particles are likely to occur, and thereby it becomes difficult for a finally obtained liquid developer to exhibit sufficient properties.

<Water-Based Emulsion Preparing Step>

Next, by using the kneaded material K7, a water-based emulsion comprised of a water-based dispersion medium constituted from a water-based solvent in which a dispersoid constituted from a toner material is dispersed is prepared (water-based emulsion preparing step). In this step, if the kneaded material K7 contains a self-dispersible type resin described above, a water-based emulsion obtained in this step can have satisfactory dispersion state of a dispersoid even in the case where no dispersant is used or a very small amount of dispersant is used. Further, since a water-based liquid is used as a dispersion medium, it is possible to manufacture a liquid developer with a method harmless to environment.

The method for preparing the water-based emulsion is not particularly limited, but in the present embodiment, a water-based emulsion is prepared by obtaining a solution in which at least a part of the kneaded material K7 is dissolved, and then by dispersing such a solution into a water-based solvent. In this connection, it should be noted that in this specification the term “emulsion” means a dispersion liquid comprised of a liquid state dispersion medium and a liquid state dispersoid (dispersion particles) dispersed in the dispersion medium, and the term “emulsion” means a suspension liquid (including suspension colloid). Further, in the case where a liquid state dispersoid and a solid state dispersoid exist in a dispersion liquid, the term “emulsion means” a dispersion liquid in which the total volume of the liquid state dispersoid is larger than the total volume of the solid state dispersoid, while the term “suspension” means a dispersion liquid in which the total volume of the solid state dispersoid is larger than the total volume of the liquid state dispersoid.

Hereinbelow, a description will be made with regard to the method for preparing the water-based emulsion.

<Preparation of Kneaded Material Solution>

In the present embodiment, a kneaded material solution (a solution of the kneaded material) in which at least a part of the kneaded material is dissolved is obtained.

The solution is prepared by mixing the kneaded material with a solvent in which at least a part of the kneaded material can be dissolved.

As for the solvent used for preparing the solution, various solvents can be used so long as at least a part of the kneaded material can be dissolved thereinto, but normally, solvents which have low mutual solubility to a water-based liquid described later (that is, a water-based liquid used for preparing the water-based emulsion) are used. For example, a liquid having a solubility of 10 g or less with respect to 100 g of a water-based liquid at a temperature of 25° C. is used.

Examples of such solvents include inorganic solvents such as carbon disulfide, and carbon tetrachloride, and organic solvents such as ketone-based solvents (e.g., methyl ethyl ketone (MEK), methyl isopropyl ketone (MIPK), and 2-heptanone), alcohol-based solvents (e.g., pentanol, n-hexanol, 1-octanol, and 2-octanol), ether-based solvents (e.g., diethyl ether, and anisole), aliphatic hydrocarbon-based solvents (e.g., hexane, pentane, heptane, cyclohexane, octane, and isoprene), aromatic hydrocarbon-based solvents (e.g., toluene, xylene, benzene, ethyl benzene, and naphthalene), aromatic heterocyclic compound-based solvents (e.g., furan, and thlophene), halide-based solvents (e.g., chloroform), ester-based solvents (e.g., ethyl acetate, isopropyl acetate, isobutyl acetate, and ethyl acrylate), nitrile-based solvents (e.g., acrylonitrile), and nitro-based solvents (e.g., nitromethane and nitroethane). These materials can be used singly or in combination of two or more of them.

The amount of the solvent contained in the solution is not limited to any specific value, but Is preferably in the range of 5 to 75 wt %, more preferably in the range of 10 to 70 wt %, and even more preferably in the range of 15 to 65 wt %. If the amount of the solvent contained in the solution is less than the above lower limit value, there is a possibility that it is difficult to dissolve the kneaded material sufficiently depending on the solubility of the kneaded material to the solvent. On the other hand, if the amount of the solvent exceeds the above upper limit value, a time required for removing the solvent in the subsequent step becomes long, the productivity of the liquid development is lowered. Further, if the amount of the solvent is too much, there is a possibility that the components which were sufficiently and homogeneously mixed to each other are phase-separated, and thereby making it difficult to make variations in the properties of the toner particles of a finally obtained liquid developer sufficiently small.

In this regard, it is to be noted that it is sufficient that at least a part of the components which constitute the kneaded material is dissolved (including a swelling state), and therefore components which were not dissolved may exist in the solution.

<Preparation of Water-Based Emulsion>

Next, a water-based emulsion is obtained by mixing the above mentioned solution with a water-based liquid. Normally, in the thus obtained water-based emulsion, a dispersoid which contains the solvent and the constituent material of the kneaded material are dispersed in the water-based dispersion medium formed from the water-based liquid.

In the present invention, the term “water-based liquid” means a liquid constituted from water and/or a liquid having good compatibility with water (for example, a liquid which has solubility of 30 g or higher with respect to 100 g of water at temperature of 25° C.). As described, the water-based liquid is constituted from water and/or a liquid having good compatibility with water, but preferably that the water-based liquid is mainly constituted from water, more preferably constituted from a liquid of which water content is 70 wt % or higher, and even more preferably constituted from a liquid of which water content is 90 wt % or higher. By using such a water-based liquid, it is possible to manufacture a liquid developer (that is, toner particles) with a method harmless to environment even if a liquid collecting apparatus (dispersion medium collecting apparatus) for collecting a dispersion medium (water-based liquid) is omitted or simplified.

Examples of the water-based liquid include water, alcohol-based solvents such as methanol, ethanol, propanol, and the like, ether-based solvents such as 1,4-dioxane, tetrahydrofuran (THF), and the like, aromatic heterocyclic compound-based solvents such as pyridine, pyrazine, pyrrole, and the like, amide-based solvents such as N,N-dimethylformamide (DMF), N,N-dimethylacetamide (DMA), and the like, nitrile-based solvents such as acetonitrile and the like, and aldehyde-based solvents such as acetaldehyde, and the like.

Further, in preparing the water-based emulsion, a dispersant or the like may be used for the purpose of improving the dispersibility of the dispersant. Examples of such a dispersant include: inorganic dispersants such as viscosity mineral, silica, tricalcium phosphate, and the like; nonionic organic dispersants such as polyvinyl alcohol, carboxymethyl cellulose, polyethylene glycol, and the like; anionic organic dispersants such as tristearic acid metal salts (e.g., aluminum salts), distearic acid metal salts (e.g., aluminum salts and barium salts), stearic acid metal salts (e.g., calcium salts, lead salts, and zinc salts), linolenic acid metal salts (e.g., cobalt salts, manganese salts, lead salts, and zinc salts), octanoic acid metal salts (e.g., aluminum salts, calcium salts, and cobalt salts), oleic acid metal salts (e.g., calcium salts and cobalt salts), palmitic acid metal salts (e.g. , zinc salts), dodecylbenzenesulfonic acid metal salts (e.g., sodium salts), naphthenic acid metal salts (e.g. calcium salts, cobalt salts, manganese salts, lead salts, and zinc salts), resin acid metal salts (e.g., calcium salts, cobalt salts, manganese salts, lead salts, and zinc salts), polyacrylic acid metal salts (e.g., sodium salts), polymethacrylic acid metal salts (e.g., sodium salts), polymaleic acid metal salts (e.g., sodium salts), metal salts of acrylic acid-maleic acid copolymers (e.g., sodium salts), polystyrenesulfonic acid metal salts (e.g., sodium salts); and cationic organic dispersants such as quaternary ammonium salts; and the like. By using the dispersant as described above in preparing the water-based emulsion, it is possible to improve the dispersibility of the dispersant. Further, it is also possible to make variations in shape and size of the dispersant in the water-based emulsion particularly small relatively easily, and also possible to make the shape of each dispersant roughly spherical shape. With these results, it is possible to obtain a liquid developer which is comprised of toner particles each formed into a roughly spherical shape and having uniform shape and size.

It is preferred that the solution is mixed with the water-based liquid while at least one of the solution or the water-based liquid is being stirred. This makes it possible to obtain an emulsion (a water-based emulsion) in which a dispersoid having small variations in its size and shape is homogeneously dispersed easily and reliably.

Examples of methods for mixing the solution and the water-based liquid include a method in which the solution is added (for example, dropped) into the water-based liquid contained in a container, a method in which the water-based liquid is added (for example, dropped) into the solution contained in a container, and the like. In these methods, the water-based material or the solution which is contained in a container is preferably being stirred. This makes it possible to exhibit the above effect more conspicuously.

The amount of the dispersoid in the water-based emulsion is not particularly limited, but preferably in the range of 5 to 55 wt %, and more preferably in the range of 10 to 50 wt %. This makes it possible to prevent bonding or aggregation of particles of the dispersoid more reliably, thereby enabling to make productivity of the toner particles (liquid developer) particularly superior.

The average diameter of the dispersant in the water-based emulsion is not particularly limited, but preferably in the range of 0.01 to 5 μm, and more preferably in the range of 0.1 to 3 μm. This makes it possible to prevent bonding or aggregation of particles of the dispersoid in the water-based emulsion more reliably, thereby enabling to make the size of the toner particles finally obtained optimum. In this regard, it is to be noted that the term “average diameter” means an average diameter per the reference number of particles.

Further, although the above description was made with regard to the case that the components of the kneaded material are contained in the dispersoid in the water-based emulsion, a part of the components of the kneaded material may be contained in the dispersion medium.

Furthermore, the water-based emulsion may contain additional components other than the above-mentioned components. Examples of such additional components include a charge controlling agent, magnetic powder and the like.

Example of the charge controlling agent include metal salts of benzoic acid, metal salts of salicylic acid, metal salts of alkyl salicylic acid, metal salts of catechol, metal-containing bisazo dyes, nigrosine dyes, tetraphenylborate derivatives, quaternary ammonium salts, alkyl pyridinium salts, chlorinated polyesters, nitrohumic acid, and the like.

Examples of the magnetic powders include powders of metal oxides such as magnetite, maghemite, various ferrites, cupric oxide, nickel oxide, zinc oxide, zirconium oxide, titanium oxide, magnesium oxide, and the like, and powders of magnetic materials containing magnetic metals such as Fe, Co, and Ni.

The water-based emulsion may further contain, for example, zinc stearate, zinc oxide, or cerium oxide, in addition to the above-mentioned materials.

<Water-Based Suspension Preparing Step>

The thus obtained water-based emulsion may be brought to the water-based dispersion medium removal step described below as it is. However, in the present embodiment, a water-based suspension 3 comprised of a dispersion medium (water-based dispersion medium) and a solid state dispersoid 31 dispersed in the dispersion medium is obtained based on the water-based emulsion (in which the liquid state dispersant is dispersed in the water-based dispersion medium), and the thus obtained water-based suspension is used in the water-based dispersion medium removal step. This makes it possible to prevent undesirable aggregate of the particles in the water-based dispersion medium removal step more effectively, and as a result thereof, the uniformity in the shape and size of the toner particles can be made especially excellent. Further, since the self-dispersible type rein described above has excellent compatibility with a water-based liquid, in the case where a dispersoid of the water-based emulsion is constituted from such a self-dispersible type resin, a water-based suspension obtained in this step can also have especially excellent dispersibility of the dispersoid.

Hereinbelow, a detailed description will be made with regard to a method for preparing the water-based suspension 3.

The water-based suspension 3 can be prepared by removing the solvent which constitutes the dispersant from the water-based emulsion.

The removal of the solvent can be carried out, for example, by heating or warming the water-based emulsion or placing it in an atmosphere under reduced pressure. However, it is preferred that the water-based emulsion is heated under reduced pressure. This makes it possible to obtain a water-based suspension 3 containing a dispersoid 31 having particularly small variations in size and shape thereof relatively easily. Further, by removing the solvent as described above, it is possible to carry out a deaerating treatment in addition to the removal of the solvent. By the deaerating treatment, it is possible to reduce the amount of the dissolved air in the water-based suspension 3, and therefore when the dispersion medium 32 is removed from the droplets 9 of the water-based suspension 3 in the water-based dispersion medium removal section M3 of the dry fine particle producing apparatus M1, it is possible to prevent generation of air bubble in the water-based suspension 3 in a effective manner. As a result, it is possible to prevent toner particles having irregular shapes (such as void particles and defect particles) from entering (or being mixed into) a finally obtained liquid developer effectively.

When the water-based emulsion is heated (or warmed), the heating temperature is preferably in the range of 30 to 110° C., and more preferably in the range of 40 to 100° C. If the heating temperature is set to a value within the above range, it is possible to remove the solvent immediately while preventing generation of a dispersoid 31 having irregular shapes effectively (that is, preventing rapid vaporization (boiling) of a solvent from the inside of the dispersoid of the water-based emulsion).

Further, when the water-based emulsion is placed in an atmosphere under reduced pressure, the pressure of the atmosphere in which the water-based emulsion is placed is preferably in the range of 0.1 to 50 kPa, and more preferably in the range of 0.5 to 5 kPa. If the pressure of the atmosphere in which the water-based emulsion is within the above range, it is possible to remove the solvent immediately while preventing generation of a dispersoid 31 having irregular shapes effectively (that is, preventing rapid vaporization (boiling) of a solvent from the inside of the dispersoid of the water-based emulsion).

In this regard, it should be noted that it is sufficient that the removal of the solvent is carried out to the extent that at least the dispersoid is transformed into a solid state. It is not necessary to remove substantially all the solvent contained in the water-based emulsion.

The average diameter of the dispersoid 31 contained in the water-based suspension 3 is not limited to a specific value, but preferably in the range of 0.01 to 5 μm, and more preferably in the range of 0.1 to 3 μm. This makes it possible to prevent bonding (aggregation) of the particles of the dispersoid reliably, thereby enabling the size of finally obtained toner particles to be optimum size.

<Water-Based Dispersion Medium Removal Step>

Next, by removing the water-based dispersion medium from the water-based dispersion liquid (water-based suspension 3), dry fine particles corresponding to the dispersoid of the water-based dispersion liquid (water-based suspension 3) is obtained (water-based dispersion medium removal step). The dry fine particles obtained in this way are used as toner particles of a liquid developer.

The removal of the water-based dispersion medium may be carried out by any method, but preferably carried out by intermittently ejecting droplets of a dispersion liquid (water-based dispersion liquid) comprised of a water-based dispersion medium and a dispersoid dispersed in the dispersion medium. This makes it possible to carry out the removal of the water-based dispersion medium efficiently while preventing aggregation of the dispersoid effectively. Further, since the removal of the water-based dispersion medium is carried out by intermittently ejecting droplets of the water-based dispersion liquid, even in the case where a part of the solvent remains In preparing the water-based suspension, it is possible to remove the remaining solvent together with the water-based dispersion medium in an effective manner.

In particular, in the present embodiment, the removal of the water-based dispersion medium is carried out using a dry fine particle production apparatus (toner particle production apparatus) as shown in FIGS. 2 and 3.

<Dry Fine Particle Production Apparatus>

As shown in FIG. 2, the dry fine particle production apparatus (toner particle production apparatus) M1 includes head portions M2 for intermittently ejecting the water-based suspension (water-based dispersion liquid) 3 in the form of droplets 9 as described above, a water-based suspension supply portion (water-based dispersion liquid supply portion) M4 for supplying the water-based suspension 3 to the head portions M2, a dispersion medium removal portion M3 in which the dispersion medium is removed while the water-based suspension 3 (droplets 9) in the form of droplets (fine particles) ejected from the head portions M2 is being conveyed, thereby to obtain dry fine particles (toner particles) 4, and a collecting portion M5 for collecting produced dry fine particles (toner particles) 4.

The water-base suspension supply portion M4 is not particularly limited as long as it has the function of supplying the water-based suspension 3 to the head portions M2. The water-based suspension supply portion M4 may be provided with a stirring means 41M for stirring the water-based suspension 3 as shown in FIG. 2. By providing such a stirring means 41M, even in the case where the dispersoid 31 is hard to be dispersed in the dispersion medium (water-based dispersion medium) 32, it is possible to supply the water-based suspension which is in a state that the dispersoid 31 is sufficiently homogeneously dispersed in the dispersion medium to the head portions M2.

Each of the head portions M2 has a function of ejecting the water-based emulsion 3 in the form of fine droplets (fine particles) 9.

Further, each of the head portions M2 has a dispersion liquid storage portion M21, a piezoelectric device (element) M22, and an election port (nozzle) M23. In the dispersion liquid storage portion M21, the water-based suspension 3 is stored.

The water-based suspension 3 stored in the dispersion liquid storage portion M21 is ejected from the ejection port M23 in the form of droplets 9 into the dispersion medium removal portion M3 when a pressure pulse (piezoelectric pulse) is applied.

The shape of the ejection portion M23 is not particularly limited, but preferably it is formed into a substantially circular shape. By forming the ejection portion M23 into such a shape, it is possible to raise sphericity of the ejected water-based suspension 3 and the dry fine particle 4 formed in the dispersion medium removal portion M3.

When the ejection portion M23 has such a substantially circular shape, the diameter thereof (that is, nozzle diameter) is preferably in the range of 5 to 500 μm, and more preferably in the range of 10 to 200 μm. If the diameter of the ejection portion M23 is less than the above lower limit value, clogging is likely to occur and therefore there is a case that variations in the size of the droplets 9 to be ejected become larger. On the other hand, if the diameter of the ejection portion M23 exceeds the above upper limit value, there is a possibility that the water-based suspension 3 (droplets 9) to be ejected contains air bubbles inside thereof depending on the relative power balance between the negative pressure of the dispersion liquid storage portion M21 and the surface tension of the nozzle.

Further, it is preferred that the a portion in the vicinity of the ejection portion M23 of each head portion M2 (that is, an inner surface of the nozzle aperture of each ejection portion M23 and a surface of the head portions M2 in which the ejection portions M23 are provided (the lower surface in the drawing)) has a liquid repellency (water repellency). This makes it possible to prevent the water-based suspension 3 from adhering around the ejection portion effectively. As a result, it is possible to prevent a poor formation of droplets and occurrence of defective ejection of the water-based suspension 3. Further, since adhering of the water-based suspension 3 around the ejection portion is prevented effectively, the shape stability of the droplets to be ejected is improved (variations in shape and size of the respective droplets are made small), and thus variations in shape and size of toner particles to be finally obtained can be made small.

Examples of a material having such a liquid repellency include fluorobased resins such as polytetrafluoroetylene (PTFE) and silicone-based materials.

As shown in FIG. 3, each of the piezoelectric devices M22 is formed by laminating a lower electrode (a first electrode) M221, a piezoelectric element M222, and an upper electrode (a second electrode) M223 in this order from the bottom side. In other words, each of the piezoelectric devices M22 has a structure in which the piezoelectric element M222 is provided between the upper electrode M223 and the lower electrode M221.

The piezoelectric device M22 functions as a vibration source, and the diaphragm M24 is vibrated by the piezoelectric device (vibration source) M22 to instantaneously increase the internal pressure of the ejection liquid storage portion M21.

In particular, in each of the head portions M2, the piezoelectric element M222 keeps its original shape in a state where a predetermined elect signal from a piezoelectric device driving circuit (not shown in the drawings) is not inputted, that is, in a state where a voltage is not applied across the lower electrode M221 and the upper electrode M223 of the piezoelectric device M22. At this time, since the diaphragm M24 also keeps its original shape, the volume of the dispersion liquid storage portion M21 is not changed. That is, the water-based suspension 3 is not ejected through the ejection portion M23.

On the other hand, the piezoelectric element M222 changes its shape when a predetermined eject signal from the piezoelectric device driving circuit is inputted, that is, when a predetermined voltage is applied across the lower electrode M221 and the upper electrode M223 of the piezoelectric device M22. As a result, the diaphragm M24 is significantly bent (toward the lower side in FIG. 3), so that the volume of the dispersion liquid storage portion M21 is reduced(changed). At this time, the pressure in the dispersion liquid storage portion M21 is instantaneously increased, so that the water-based suspension 3 is ejected in the form of droplets through the ejection portion M23.

When single ejection of the water-based suspension 3 is finished, namely one droplet is formed, the piezoelectric device driving circuit stops a voltage from being applied across the lower electrode M221 and the upper electrode M223. As a result, the piezoelectric device M22 is returned to its almost original shape so that the volume of the ejection liquid storage portion M21 is increased. At this time, since pressure is exerted on the water-based suspension 3 in the direction from the water-based suspension supply portion M4 to the ejection portion M23 (that is, in the positive direction), it is possible to prevent air from entering the dispersion liquid storage portion M21 through the ejection portion M23. Then, the water-based suspension 3 in an amount equal to the ejected amount thereof is supplied to the dispersion liquid storage portion M21 from the water-based suspension supply portion M4.

By carrying out predetermined periodic application of a voltage in such a manner as described above, the water-based suspension 3 in the form of a droplet is repeatedly ejected due to vibration of the piezoelectric device M22.

As described above, by carrying out ejection (discharge) of the water-based suspension 3 by the use of a pressure pulse due to vibration of the piezoelectric element M222, it is possible to eject the water-based suspension 3 intermittently drop by drop with the shape of each droplet 9 being stable. As a result, it is possible to make variations in shape and size of respective toner particles extremely small, thereby enabling to produce toner particles having high sphericity (a shape close to a geometrically perfect spherical shape) relatively easily.

Further, by ejecting the dispersion liquid by the use of vibration of the piezoelectric element, it is possible to eject the dispersion liquid at predetermined intervals more reliably. This makes it possible to effectively prevent collision or aggregation between the ejected droplets 9 of the dispersion liquid, thus resulting in preventing formation of defective dry fine particles 4 effectively.

The initial velocity of the water-based suspension 3 (droplets 9) at the time when the water-based suspension 3 is ejected from the head portions M2 into the dispersion medium removal portion M3 is preferably in the range of, for example, 0.1 to 10 m/sec, more preferably in the range of 2 to 8 m/sec. If the initial velocity of the water-based suspension 3 is less than the above lower limit value, productivity of toner particles is lowered. On the other hand, the initial velocity of the water-based suspension 3 exceeds the above upper limit value, the finally obtained toner particles tend to have a lower degree of sphericity.

The viscosity of the water-based suspension 3 ejected from the head portions M2 is not limited to any specific value, but is preferably in the range of, for example, 0.5 to 200 (mPa·s), more preferably in the range of 1 to 25 (mPa·s). If the viscosity of the water-based suspension 3 is less than the above lower limit value, it is difficult to control the size of each droplet of the water-based suspension to be ejected properly, thus resulting in a case where the finally obtained toner particles have large variations in size. On the other hand, if the viscosity of the water-based suspension 3 exceeds the above upper limit value, there is a tendency that each of the formed droplets has a larger diameter, the ejecting velocity of the water-based suspension 3 becomes low, and the amount of energy required to eject the water-based suspension 3 becomes large. In a case where the viscosity of the water-based suspension 3 is especially high, it is impossible to eject the water-based suspension 3 in the form of droplets.

The water-based suspension 3 to be ejected from the head portions M2 may be cooled in advance. By cooling the water-based suspension 3 in such a manner, it is possible to prevent undesirable evaporation (volatilization) of the dispersion medium 32 from the water-based suspension 3 at the vicinity of the ejection portions M23 effectively. As a result, it is possible to prevent changes In the ejected amount of the water-based suspension 3 which are caused by the fact that the diameter of each ejection portion is reduced with the elapse of time, thereby enabling to obtain toner particles having small variations in shape and size of respective particles.

The ejected amount of one droplet of the water-based suspension 3 slightly varies depending on the content of the dispersoid 31 in the water-base suspension 3, but is preferably in the range of 0.05 to 500 pl, more preferably in the range of 0.5 to 50 pl. By setting the ejected amount of one droplet of the water-based suspension 3 to a value within the above range, it is possible to obtain dry fine particles each having an appropriate diameter.

Further, the average diameter of the droplets 9 ejected from the head portions M2 also varies depending on the content of the dispersoid 31 in the water-base suspension 3, but is preferably in the range of 1.0 to 100 μm, more preferably in the range of 5 to 50 μm. By setting the average diameter of the droplets 9 of the water-based suspension 3 to a value within the above range, it is possible to obtain dry fine particles each having an appropriate diameter.

The frequency of the piezoelectric device M22 (the frequency of an piezoelectric pulse) is not limited to any specific value, but is preferably in the range of 1 kHz to 500 MHz, more preferably in the range of 5 kHz to 200 MHz. If the frequency of the piezoelectric device M22 is less than the above lower limit value, productivity of toner particles is lowered. On the other hand, if the frequency of the piezoelectric device M22 exceeds the above upper limit value, there is a possibility that the ejection of the water-based suspension 3 cannot follow the frequency of the piezoeleotric device M22 so that the sizes of the droplets of the water-based suspension 3 become different from each other. As a result, there is a possibility that dry fine particles 4 (toner particles) finally obtained have large variations In their size.

The dry fine particle production apparatus M1 shown in FIG. 1 is provided with a plurality of head portions M2. From each of the head portions M2, a water-based emulsion 3 in the form of droplets (droplets 9) is ejected to the dispersion medium removal portion M3.

The water-based suspension 3 may be ejected at substantially the same time from all the head portions M2, but it is preferred that the water-based suspension 3 is ejected in such a manner that the timing of ejection is different in at least two adjacent head portions M2. This makes it possible to prevent collision and undesirable aggregation effectively between the water-based suspension 3 in the form of droplets, namely between the droplets 9 ejected from the adjacent head portions M2, before the dry fine particles 4 are formed.

Further, as shown in FIG. 2, the dry fine particle production apparatus M1 has a gas stream supply means M10, and the gas stream supply means M10 is adapted to inject gas at a substantially even pressure through a duct M101 from each of the gas injection openings M7 provided between the adjacent head portions M2. This makes it possible to convey the droplets 9 of the water-based suspension 3 intermittently ejected from the ejection portions M23 with the distance between the droplets 9 being maintained, thereby enabling to prevent collision and aggregation between the droplets effectively to obtain dry fine particles 4. As a result, it is also possible to obtain dry fine particles having small variations in their size and shape.

Further, by injecting gas supplied from the gas stream supply means M10 through the gas injection openings M7, it is possible to form an air stream flowing in substantially one direction (that is, in a downward direction in FIG. 1) in the dispersion medium removal portion M3. Such a gas stream makes it possible to efficiently convey the dry fine particles 4 produced in the dispersion medium removal portion M3. As a result, collection efficiency of dry fine particles 4 is improved, and thus productivity of a liquid developer is also improved.

Furthermore, by injecting gas through the gas injection openings M7, an air flow curtain is formed between the droplets 9 ejected from the adjacent head portions M2. Such an air curtain makes it possible to prevent collision and aggregation between the droplets effectively.

The gas stream supply means M10 is equipped with a heat exchanger M11. By providing such a heat exchanger M11, it is possible to set the temperature of gas to be injected from the gas injection openings M7 to an appropriate value, thereby enabling to efficiently remove the dispersion medium 32 from the water-based suspension 3 in the form of droplets which have been ejected into the dispersion medium removal portion M3.

Further, by providing such gas stream supply means M10, it is possible to control the dispersion medium removal rate for removing the dispersion medium 32 from the droplets of the water-based suspension 3 ejected from the ejection portions M23 easily by adjusting the amount of a gas stream to be supplied.

The temperature of gas to be injected from the gas injection openings M7 varies depending on the compositions of the dispersoid 31 and the dispersion medium 32 contained in the water-based suspension 3, but is preferably in the range of 0 to 70° C., more preferably in the range of 15 to 60° C. By setting the temperature of gas to be injected from the gas injection openings M7 to a value within the above range, it is possible to remove the dispersion medium 32 effectively from the droplets 9 while maintaining shape uniformity and shape stability of dry fine particles 4 obtained at a sufficiently high level.

The humidity of gas to be injected from the gas injection openings M7 is preferably 50% RH or less, more preferably 30% RH or less. By setting the humidity of gas to be injected from the gas injection openings M7 to 50% RH or less, it is possible to remove the dispersion medium 32 contained in the water-based suspension 3 efficiently in the dispersion medium removal portion M3, thereby further improving the productivity of the dry fine particles 4.

The dispersion medium removal portion M3 is constructed from a tubular housing M31. In order to maintain the inside of the dispersion medium removal portion M3 at a temperature within a predetermined range, a heat source or a cooling source may be provided inside or outside the housing M31, or the housing M31 may be formed as a jacket having a passage of a heat medium or a cooling medium.

In the dry fine particle production apparatus shown in FIG. 1, the pressure inside the housing M31 is adapted to be adjusted by pressure controlling means M12. By adjusting the pressure inside the housing M31, it is possible to produce dry fine particles more effectively, and as a result, productivity of a liquid developer is improved. Further, in the structure shown in the drawing, the pressure controlling means M12 is connected to the housing M31 through a connecting pipe M121. Further, a diameter expansion portion M122 is formed in the vicinity of the end portion of the connecting pipe M121 at a side which is connected to the housing M31, and a filter M123 for preventing the dry fine particles 4 and the like from being sucked into the, pressure controlling means M12 is provided in the end of the diameter expansion portion M122.

The pressure inside the housing M31 is not limited to any specific value, but is preferably 150 kPa or less, more preferably in the range of 100 to 120 kPa, even more preferably in the range of 100 to 110 kPa. By setting the pressure in the housing M31 to a value within the above range, it is possible to prevent effectively the dispersion medium 32 from being removed rapidly from the droplets 9 (that is, boiling phenomenon of the droplets 9). As a result, it is possible to produce dry fine particles 4 effectively while preventing formation of defective dry fine particles 4 reliably. In this connection, it is to be noted that the pressure inside the housing M31 may be substantially the same or different from each other at various positions thereof.

Further, voltage apply means M8 for applying a voltage to the inner surface of the housing M31 is connected to the housing M31. By applying a voltage of the same polarity as the dry fine particles 4 (droplets 9) to the inner surface of the housing M31 by the use of the voltage apply means M8, it is possible to obtain such effects as described below.

Generally, the dry fine particles 4 are positively or negatively charged. Therefore, when there is any charged matter of polarity opposite to that of the dry fine particles 4, the phenomenon in which the dry fine particles 4 are electrostatically attracted and adhered to the charged matter occurs. On the other hand, when there is any charged matter of the same polarity as that of the dry fine particles 4, the charged matter repels each another, thereby effectively preventing the phenomenon in which the dry fine particles 4 adhere to the surface of the charged matter. For this reason, by applying a voltage of the same polarity as that of the dry fine particles 4 to the side of the inner surface of the housing M31, it is possible to prevent effectively the dry fine particles 4 from adhering to the inner surface of the housing M31. As a result, it is also possible to prevent effectively the formation of defective dry fine particles 4 as well as to improve the collection efficiency of the dry fine particles 4.

The housing M31 further includes a reduced-diameter portion M311 in the bottom portion thereof. In the reduced-diameter portion M311, the inner diameter thereof is reduced toward the lower side in FIG. 2. By providing such a reduced-diameter portion M311, it is possible to collect the dry fine particles 4 efficiently.

The dry fine particles 4 obtained in this way are collected in the collection portion M5.

Normally, the thus obtained dry fine particles 4 have size and shape corresponding to each dispersoid 31. Therefore, a finally obtained liquid developer contains toner particles each having a relatively small diameter and a high degree of roundness (sphericity) and having small variations in shape and size of the respective particles.

Further, the thus obtained dry fine particles 4 may be particles obtained by removing the dispersion medium 32 of the water-based suspension 3, and in such a case a part of the dispersion medium may remain inside thereof.

Furthermore, the thus obtained dry fine particles 4 may be subjected to the dispersion step described later as they are or subjected to various treatments such as heat treatment. This makes it possible to further enhance the mechanical strength (shape stability) of the dry fine particles (toner particles) and the water content in the dry fine particles can be lowered. Further, it is also possible to lower the water content of the dry fine particles 4 as is the same as the above by subjecting the thus obtained dry fine particles to a treatment such as aeration, or placing the dry fine particles 4 in an atmosphere under reduced pressure.

Moreover, the thus obtained dry fine particles 4 may be subjected to other various treatments such as classification, and external addition and the like.

<Dispersing Step>

Next, the dry fine particles 4 obtained through the processes described above is dispersed into a high insulation liquid (dispersing step). In this way, it is possible to obtain a liquid developer in which toner particles comprised of the dry fine particles 4 are dispersed in the high insulation liquid.

Various liquids may be used as the high insulation liquid if the liquids have sufficiently high insulation properties. Specifically, a liquid having an electric resistance of 10⁹ Ωcm or more at room temperature (20° C.) is preferably used, more preferably a liquid having an electric resistance of 10¹¹ Ωcm or more is used, and even more preferably a liquid having an electric resistance of 10¹³ Ωcm or more is used.

Further, it is preferred that the high insulation liquid has a dielectric constant of 3.5 or less.

Examples of such high insulation liquids that satisfy the above conditions include octane, isooctane, decane, isodecane, decaline, nonane, dodecane, isodecane, cyclohexane, cyclooctane, cyclodecane, benzene, toluene, xylene, mesitylene, ISOPAR E, ISOPAR G, ISOPAR H, ISOPAR L (“ISOPAR” is a product name of Exxon Mobil), SHELLSOL 70, SHELLSOL 71 (“SHELLSOL” is a product name of Shell Oil), Amsco OMS, Amsco 460 solvent (“Amsco” is a product name of Spirit Co., Ltd.), silicone oil, plant oil, and modified compounds or mixtures thereof.

Various methods can be used for dispersing the dry fine particles 4 into the high insulation liquid. However, it is preferred that the dispersion is carried out by adding the dry fine particles 4 into a high insulation liquid that is being stirred This makes it possible to prevent undesirable aggregation of the dry fine particles 4 in preparing the liquid developer, so that the obtained liquid developer can keep a satisfactory dispersing state of the toner particles 4 for a long period of time in a stable manner.

In the production method as described above, a dispersant (dispersing agent) may be used as described above, but it is preferred that the amount of the dispersant is a relatively small (for example, 2 parts by weight or less with respect to 100 parts by weight of the resin material). In particular, in the case where the self-dispersible type resin described above is used, superior dispersibility can be obtained using only an extremely small amount of dispersant or without using any dispersant, so that it is preferable to use no dispersant. This makes it possible to prevent an adverse effect caused by a remaining dispersant in the finally obtained liquid developer.

<Liquid Developer>

The liquid developer obtained as described above has small variations in shape and size of the toner particles. Therefore, in such a liquid developer, toner particles are easy to migrate in the high insulation liquid (that is, in the liquid developer), and thus it is advantageous in high speed development. Further, since the toner particles have small variations in their shape and size and thus they have superior dispersibility, so that settle down and floating of the toner particles in the liquid developer are prevented effectively. Therefore, such a liquid developer can keep superior stability for a long period of time.

The average particle size (diameter) of the toner particles in the liquid developer obtained as described above is preferably in the range of 0.1 to 5 μm, more preferably in the range of 0.4 to 4 μm, even more preferably in the range of 0.5 to 3 μm. If the average particle size of the toner particles is within the above range, it is possible to make resolution of a toner image formed from the liquid developer (liquid toner) sufficiently high with small variations in properties of the toner particles such as chargeable properties or fixing properties, and especially high reliability as a whole of a liquid developer.

Further, it is preferred that a standard deviation of particle size among the toner particles which constitute the liquid developer is 3.0 μm or less, more preferably in the range of 0.1 to 2.0 μm and even more preferably in the range of 0.1 to 1. 0 μm. When the standard deviation of particle size lies within the above range, variations in electrification properties, fixing properties, etc are especially small, thereby further improving the reliability of the liquid developer as a whole.

Furthermore, it is also preferred that an average roundness R represented by the following formula (I) is 0.85 or higher, more preferably in the range of 0.90 to 0.99, even more preferably 0.95 to 0.99.
R=L₀/L₁ (I)
wherein L₁ (μm) represents the circumference of projected image of a toner particle that is a subject of measurement, and L₀ (μm) represents the circumference of a perfect circle (a geometrically perfect circle) having the same area as that of the projected image of the toner particle that is a subject of measurement.

When the average roundness R of the toner particles is within the above range, the transfer efficiency and the mechanical strength of the toner particles can be made excellent while the particle size of the toner particles are made sufficiently small.

In this case, it is preferred that a standard deviation of the average roundness among the toner particles is 0.15 or less, more preferably in the range of 0.001 to 0.10, even more preferably 0.001 to 0.05. When the standard deviation of average roundness among the toner particles lies within the above range, variations in electrification properties, fixing properties, etc are especially small, thereby further improving the reliability of the liquid developer as a whole.

As described above, in the production method of the present invention, it is preferred that a liquid developer is produced using an extremely small amount of a dispersant or without using any dispersant. In this way, it is possible to obtain a liquid developer containing substantially no dispersant. In this regard, it is preferable that the liquid developer contains a dispersant of 5 wt % or less, more preferable that the liquid developer contains a dispersant of 2 wt % or less, and even more preferable that the liquid developer contains substantially no dispersant.

Next, a description will be made with regard to preferred embodiments of an image forming apparatus to which a liquid developer of the present invention can be applied.

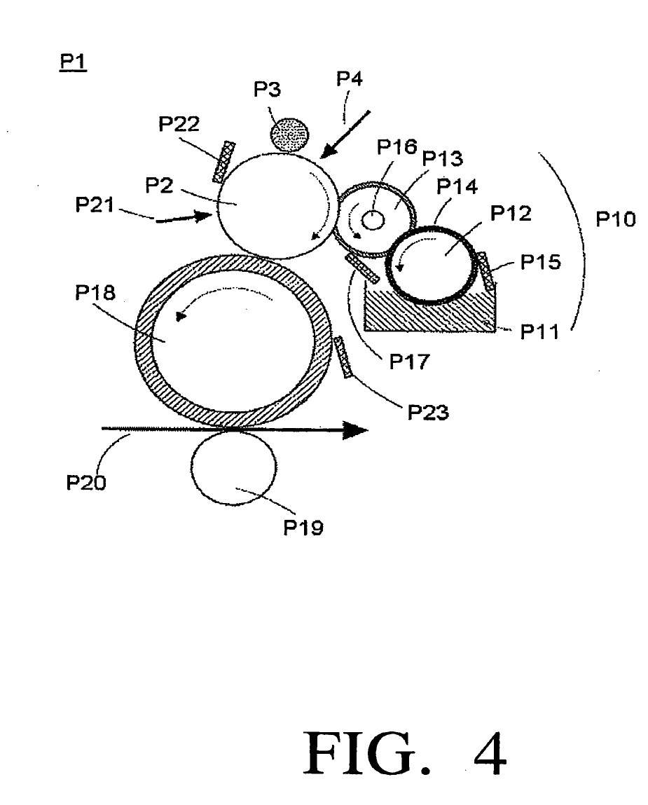

FIG. 4 is an illustration which shows one example of a contact type image forming apparatus to which the liquid developer of the present invention can be applied. The image forming apparatus P1 includes a photoreceptor P2 in the form of a cylindrical drum. After the surface of the photoreceptor P2 is uniformly charged with a charging device P3 made of an epichlorohydrin rubber or the like, exposure P4 corresponding to the information to be recorded is carried out using a laser diode or the like so that an electrostatic latent image is formed.

A developer P10 has an application roller P12 a part of which is immersed in a developer container P11 and a development roller P13. The application roller P12 is formed form, for example, a gravure roller made of stainless steel or the like, which rotates with opposing to the development roller P13. On the surface of the application roller P12, a liquid developer application layer P14 is formed, and the thickness of the layer is adapted to be kept constant by a metering blade P15.

Further, a liquid developer is transferred from the application roller P12 to the development roller P13. The development roller P13 is constructed from a metallic roller core member P16 made from stainless steel or the like, a low hardness silicone rubber layer provided on the metallic core member P16, and a resin layer made of a conductive PFA (polytetrafluoroetylene-perfluorovinylether copolymer) formed on the silicone rubber layer. The development roller P13 is adapted to rotate at the same speed as the photoreceptor P2 to transfer the liquid developer to a latent image section. A part of the liquid developer remaining on the development roller P13 after it has been transferred to the photoreceptor P2 is removed by the a development roller cleaning blade P17 and then collected in the developer container P11.

Further, after a toner image is transferred from the photoreceptor to an intermediate transfer roller P18, the photoreceptor is discharged with discharging light P21, and a toner which has not been transferred and remains on the photoreceptor P2 is removed by a cleaning blade P22 made of a urethane rubber or the like.

In a similar manner, a toner which is not transferred and remains on the intermediate transfer roller P18 after the toner image has been transferred to an information recording medium P20 is removed by a cleaning blade P23 made of a urethane rubber or the like.

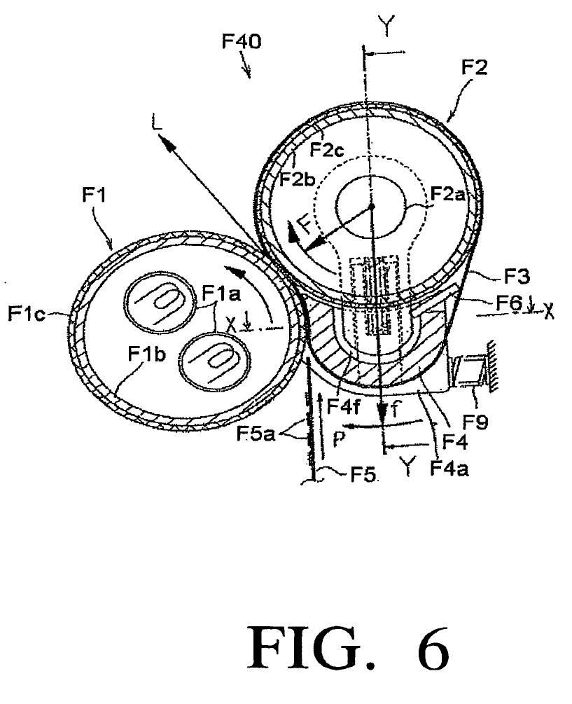

The toner image formed on the photoreceptor P2 is transferred to the intermediate transfer roller P18. Then, a transfer current is supplied to a secondary transfer roller P19, and the toner image transferred on the intermediate roller P18 is transferred onto the recording medium P20 such as a paper which passes between the intermediate transfer rollers P18 and the secondary transfer roller P19. Thereafter, the toner image on the recording medium P20 is fixed thereto using a fixing unit shown in FIG. 6.

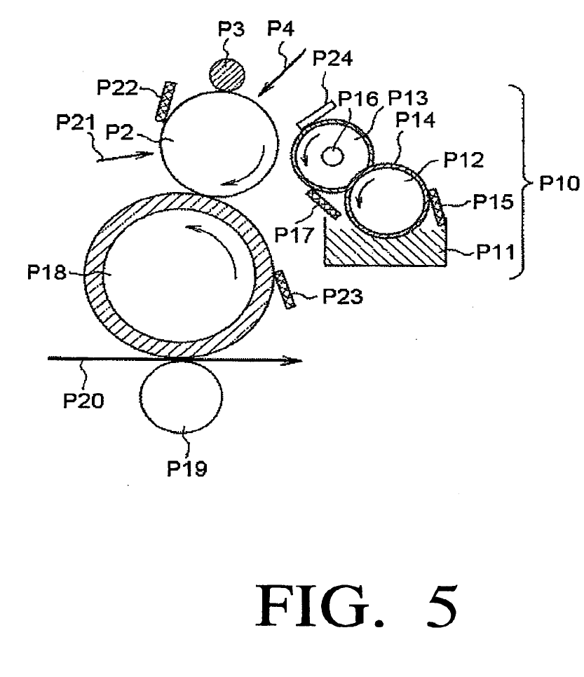

FIG. 5 shows one example of a non-contact type image forming apparatus to which the liquid developer according to the present invention can be applied. In such a non-contact type image forming apparatus, a development roller P13 is provided with a charging blade 24 which is formed from a phosphor-bronze plate having a thickness of 0.5 mm. The charging blade 24 has a function of causing a layer of the liquid developer to be charged by contacting it. Further, since an application roller P12 is a gravure roller, a layer of a developer having irregularities which correspond to irregularities on the surface of the gravure roller is formed on the development roller P13. The charging blade 24 also has a function of uniforming the irregularities formed on the development roller P13. The orientation of the charging blade 24 is either of a counter direction or a trail direction with respect to the rotational direction of the development roller. Further, the charging blade 24 may be in the form of a roller not a blade.

Preferably, between the development roller P13 and the photoreceptor P2, there is formed a gap whose width is 200 μm to 800 μm, and an AC voltage having 500 to 3000 Vpp and a frequency of 50 to 3000 Hz which is superimposed on a DC voltage of 200 to 800 V is applied across the development roller P13 and the photoreceptor P2. Other structures of this non-contact type image forming apparatus are the same as those of the contact type image forming apparatus shown in FIG. 4.

In the foregoing, the description was made with regard to the image formation by the embodiments shown in FIGS. 4 and 5 in which a liquid developer of one color is used. However, it goes without saying that when an image is formed using color toners of a plurality of colors, a color image can be formed by using a plurality of development apparatuses corresponding to the respective colors to form images of the respective colors.

FIG. 6 is a cross-sectional view of a fixing unit, in which F1 denotes a heat fixing roller, F1a denotes halogen lamps, F1b is a roller base, F1c is an elastic body, F2 is a pressure roller, F2a is a rotation shaft, F2b is a roller base, F2c is an elastic body, F3 is a heat resistant belt, F4 is a belt tension member, F4a is a protruding wall, F5 is a sheet material, F5a is an unfixed toner image, F6 is a cleaning member, F7 is a frame, F9 is a spring, and L is a tangential line of a pressing part.

As shown in this figure, the fixing unit F40 includes the heat fixing roller (hereinafter, also referred to as “heat fuser roller”) F1, the pressure roller F2, the heat resistant belt F3, the belt tension member F4, and the cleaning member F6.

The heat fixing roller F1 has the roller base F1b formed from a pipe member having an outer diameter of about 25 mm and a thickness of about 0.7 mm. The roller base F1b is coated with the elastic body F1c having a thickness of about 0.4 mm. Further, inside the roller base F1b, two halogen lamps F1a which act as a heat source is provided. Each of the halogen lamps F1a has a tubular shape and an output of 1,050 W. The heat fixing roller F1 is rotatable in an anticlockwise direction shown by the arrow in FIG. 6. Further, the pressure roller F2 has the roller base F2b formed from a pipe member having an outer diameter of about 25 mm and a thickness of about 0.7 mm. The roller base F2b is coated with the elastic body F2c having a thickness of about 0.2 mm. The pressure roller F2 having the above structures is rotatable in a clockwise direction indicated by the arrow F in FIG. 6, and it is arranged so as to face the heat fixing roller F1 so that a pressing pressure between the heat fixing roller F1 and the pressure roller F2 becomes 10 kg or less and a nip length therebetween is about 10 mm.

As described above, each of the heat fixing roller F1 and the pressure roller F2 is formed to have a small outer diameter of about 25 mm, there is less possibility that a sheet material F5 after the fixing process is wound around the heat fixing roller F1 or the heat resistant belt F3, and thus it is not necessary to have any means for peeling off the sheet material F5 forcibly. Further, since the PFA layer having a thickness of about 30 μm is provided on the surface of the elastic member F1c of the heat fixing roller F1, the strength thereof is improved. By providing such a PFA layer, both the elastic members F1a and F2c are elastically deformed substantially uniformly though their thicknesses are different from each other, thereby forming a so-called horizontal nip. Further, there is no difference between the circumferential velocity of the heat fixing roller F1 and the conveying speed of the heat resistant belt F3 or the sheet material F5. For these reasons, it is possible to perform an extremely stable image fixation.

Further, as described above, the two halogen lamps F1a, F1a which act as a heat source are provided inside the heat fixing roller F1. These halogen lamps F1a, F1a are provided with heating elements, respectively, which are arranged at different positions. With this arrangement, by selectively lighting up any one or both of the halogen lamps F1a, F1a, it is possible to easily carry out a temperature control under different conditions such as a case where a wide sheet material is used or a narrow sheet material is used, and/or a case where a fixing nip part at which the heat resistant belt F3 is wound around the heat fixing roller F1 is to be heated or a part at which the belt tension member F4 is in slidably contact with the heat fixing roller F1 is to be heated.

The heat resistant belt F3 is a ring-shaped endless belt, and it is wound around the outer circumferences of the pressure roller F2 and the belt tension member F4 so that it can be moved with being held between the heat fixing roller F1 and the pressure roller F2 in a pressed state. The heat resistant belt P3 is formed from a seamless tube having a thickness of 0.03 mm or more. Further, the seamless tube has a two layered structure in which its surface (which is the surface thereof that makes contact with the sheet material F5) is formed of PFA, and the opposite surface thereof (that is, the surface thereof that makes contact with the pressure roller F2 and the belt tension member F4) is formed of polyimide. However, the structure of the heat resistant belt F3 is not limited to the structure described above, it may be formed from other materials. Examples of tubes formed from other materials include a metallic tube such as a stainless tube or a nickel electrocasting tube, a heat-resistance resin tube such as a silicone tube, and the like.

The belt tension member F4 is disposed on the upstream side of the fixing nip part between the heat fixing roller F1 and the pressure roller F2 in the sheet material F5 conveying direction. Further, the belt tension member F4 is pivotally disposed about the rotation shaft F2a of the pressure roller F2 so as to be movable along the arrow P. The belt tension member F4 is constructed so that the heat resistant belt F3 is extended with tension in the tangential direction of the heat fixing roller F1 in a state that the sheet material F5 does not pass through the fixing nip part. When the fixing pressure is large at an initial position where the sheet material F5 enters the fixing nip part, there is a case that the sheet material F5 can not enter the fixing nip part smoothly and thereby fixation is performed in a state that a tip part of the sheet material F5 is folded. However, in this embodiment, the belt tension member F4 is provided so that the heat resistant belt F3 is extended with tension in the tangential direction of the heat fixing roller F1 as described above, there is formed an introducing portion for smoothly introducing the sheet material F5, so that the sheet material F5 can be introduced into the fixing nip part in a stable manner.

The belt tension member F4 is a roughly semi-circular member for slidably guiding the heat resistant belt F3 (the heat resistant belt F3 slidably moves on the belt tension member F4). The belt tension member F4 is fitted into the inside of the heat resistant belt F3 so as to impart tension f to the heat resistant belt F3 in cooperation with the pressure roller F2. The belt tension member F4 is arranged at a position where a nip part is formed by pressing a part of the heat resistant belt F3 toward the heat fixing roller F1 over the tangential line L on the pressing portion at which the heat fixing roller F1 is pressed against the pressure roller F2. The protruding wall F4a is formed on any one or both of the end surfaces of the belt tension member F4 which are located in the axial direction thereof. The protruding wall F4 is provided for restricting the heat resistant belt F3 from being off to the side by abutment thereto in a case that the heat resistant belt F3 is deviated in any one of the sides. Further, a spring F9 is provided between the frame and an end portion of the protruding wall F4a which is located at an opposite side from the heat fixing roller F1 so as to slightly press the protruding wall F4a of the belt tension member F4 against the heat fixing roller F1. In this way, the belt tension member F4 is positioned with respect to the heat fixing roll F1 in slidably contact with the heat fixing roller F1.

In order to stably drive the heat resistant belt F3 by the pressure roller F2 in a state that the heat resistant belt F3 is wound around the pressure roller F2 and the belt tension member F4, the frictional coefficient between the pressure roll F2 and the heat resistant belt F3 is set to be larger than the frictional coefficient between the belt tension member F4 and the heat resistant belt F3. However, there is a case that these frictional coefficients become unstable due to enter of foreign substances between the heat resistant belt F3 and the pressure roller P2 or between the heat resistant belt F3 and the belt tension member F4, or due to the abrasion of the contacting part between the heat resistant belt F3 and the pressure roller F2 or the belt tension member F4.

Accordingly, the winding angle of the heat resistant belt F3 with respect to the belt tension member F4 is set to be smaller than the winding angle of the heat resistant belt F3 with respect to the pressure roller F2, and the diameter of the belt tension member F4 is set to be smaller than the diameter of the pressure roller F2. With this structure, the distance that the heat resistant belt F3 moves on the belt tension member F4 becomes short so that unstable factors due to deterioration with the elapse of time and disturbance can be avoided or reduced. As a result, it is possible to drive the heat resistant belt F3 with the pressure roller F2 in stable manner.

The cleaning member F6 is disposed between the pressure roller F2 and the belt tension member F4. The cleaning member F6 is provided for cleaning foreign substances or wear debris on the inner surface of the heat resistant belt F3 by slidably contacting with the inner surface of the heat resistant belt F3. By cleaning the foreign substances and wear debris in this way, it is possible to refresh the heat resistant belt F3 to eliminate the unstable factors on the frictional coefficients described above. Further, the belt tension member F4 is formed with a concave portion F4f, and this concave portion F4f is preferably used for collecting the foreign substances or wear debris eliminated from the heat resistant belt F3.

A position where the belt tension member F4 is slightly pressed against the heat fixing roller F1 is set as a nip beginning position and a position where the pressure roller F2 is pressed against the heat fixing roller F1 is set as nip ending position. The sheet material F5 enters the fixing nip part from the nip beginning position to passes through between the heat resistant belt F3 and the heat fixing roller F1, and then fed out from the nip ending position, and during these processes an unfixed toner image F5a is fixed on the sheet material F5 and then the sheet material F5 is discharged along the tangential line L of the pressing part between the heat fixing roller F1 and the pressing roller F2.

In the foregoing, the present invention was described based on the preferred embodiments, but the present invention is not limited to these embodiments.

For example, each element constituting the dry fine particle production apparatus may be replaced with other element that exhibits the same or similar function, or additional element may be added to the apparatus.

Further, the liquid developer of the present invention is not limited to one that is used in the image forming apparatus as described above.

Furthermore, in the above described embodiments, after the dry fine particles obtained in the water-based dispersion medium removal step is once collected, the dry fine particles are subjected to the dispersion step. However, the dry fine particles may be directly subjected to the dispersion step without collecting the dry fine particles as powder. Further, the dry fine particle production apparatus shown in the drawings may be of the type that stores a high insulation liquid therein and has a dispersion portion to which produced dry fine particles are supplied. This makes it possible to produce a liquid developer more effectively and can be stored and prevent occurrence of undesirable aggregation among the dry fine particles more effectively.

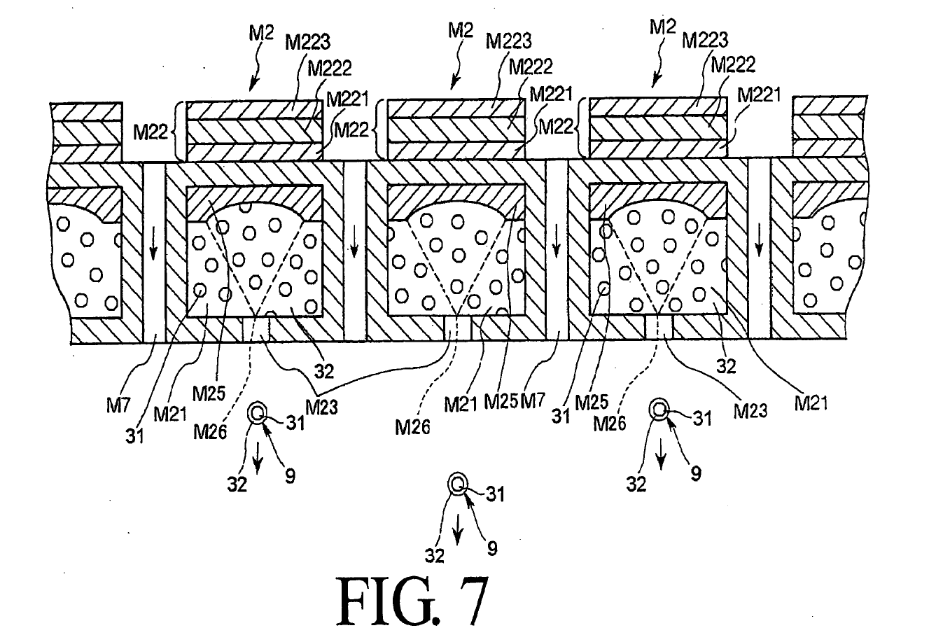

Moreover, as shown in FIG. 7, an acoustic lens (a concave lens) M25 may be provided in each head portion M2. By providing such an acoustic lens M25, it is possible to converge a pressure pulse (vibration energy) generated by a piezoelectric device M22 at a pressure pulse convergence portion M26 provided in the vicinity of each ejection portion M23. Therefore, vibration energy generated by the piezoelectric device M22 is efficiently used as energy for ejecting the water-based suspension 3. Consequently, even when the water-based suspension 3 stored in the dispersion liquid storage portion M21 has a relatively high viscosity, the water-based suspension 3 is ejected from the ejection portion M23 reliably. Furthermore, even when the water-based suspension 3 stored in the dispersion liquid storage portion M21 has a relatively large cohesive force (surface tension), the water-based suspension 3 is ejected in the form of fine droplets. As a result, it is possible to control the dry fine particles (toner particles) 9 so as to have a relatively small particle size easily and reliably.

As described above, by the use of the head portion as shown in FIG. 7, it is possible to control the dry fine particles 4 so that they have desired shape and size, even when a material having a relatively high viscosity or a material having a relatively large cohesive force is used as the water-based suspension 3. This extends the range of material choices, thereby enabling to produce toner particles having desired properties easily.

Further, by the use of the head portions as shown in FIG. 7, since the water-based suspension 3 is ejected using a convergent pressure pulse, the water-based suspension 3 in the form of droplets each having a relatively small size can be ejected, even in a case where the area (the area of an opening) of the ejecting portion M23 is relatively large. In other words, even in a case where it is desired that the dry fine particles 4 have a relatively small particle size, the area of the ejection portion M23 may be large. This makes it possible to prevent the occurrence of clogging in the ejection portion M23 more effectively even when the water-based suspension 3 has a relatively high viscosity.

In this regard, although in the head portions as shown in FIG. 7 a concave lens is used as the acoustic lens, the acoustic lens is not limited thereto. For example, a fresnel lens or an electronic scanning lens may also be used as an acoustic lens.

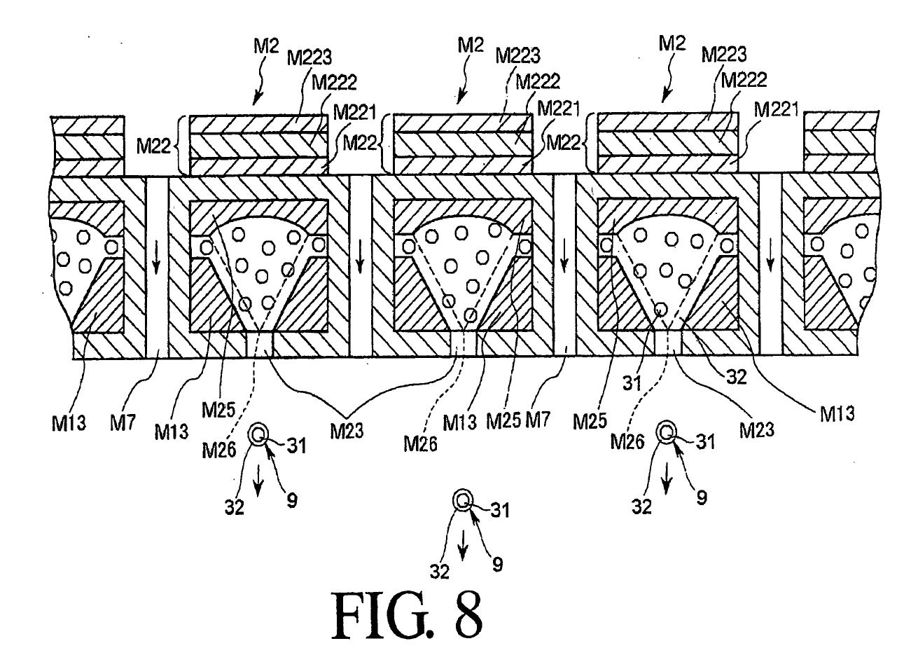

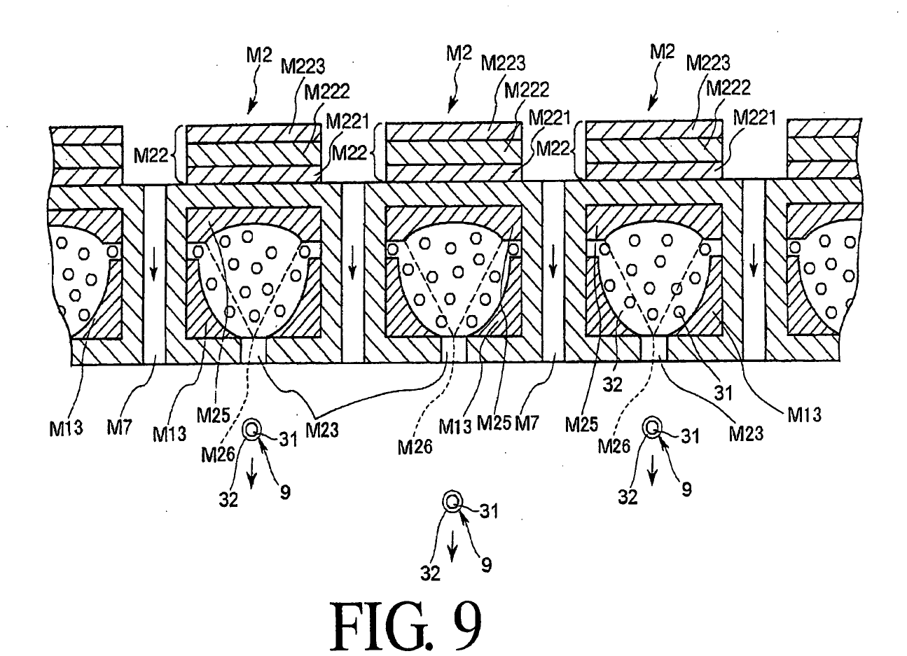

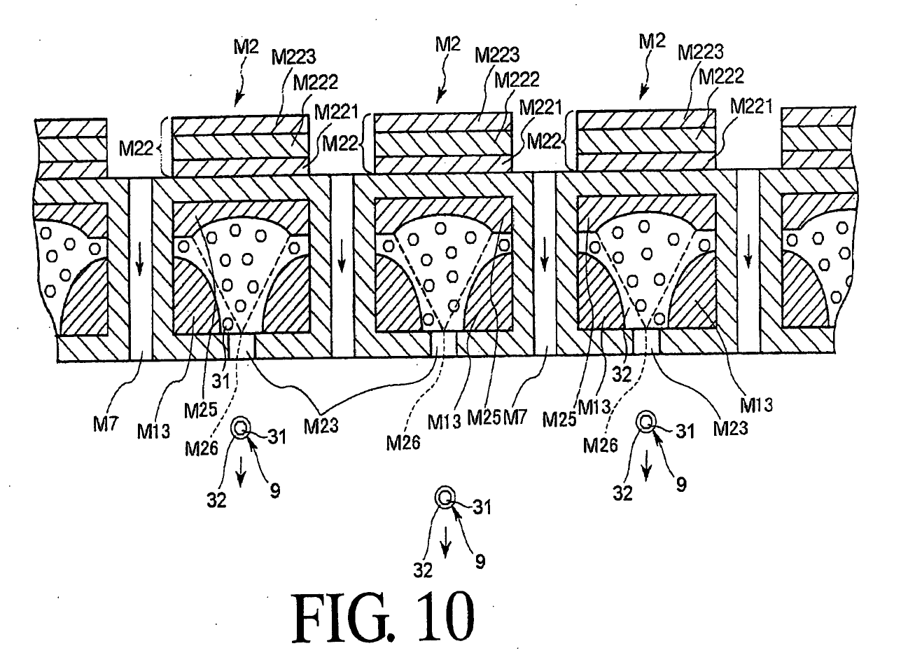

Further, head portions as shown in FIG. 8 to FIG. 10 can be used instead of the head portions of the dry fine particle production apparatus in the above embodiment. In particular, a focusing member M13 having a shape convergent toward the ejection portion M23 may be provided between the acoustic lens M25 and the ejection portion M23, as shown in FIGS. 8 to 10. Such a focusing member helps the convergence of a pressure pulse (vibration energy) generated by the piezoelectric device M22, and therefore the pressure pulse generated by the piezoelectric device M22 is utilized more efficiently.

Furthermore, although in each of the embodiments described above the constituent material of the toner particles is contained in a dispersoid as a solid component thereof, but at least a part of the constituent material of the toner particles may be contained in a dispersion medium.

Further, although each of the embodiments described above has a structure in which the dispersion liquid (water-based suspension) is intermittently ejected from the head portions by the use of a piezoelectric pulse, the dispersion liquid may be ejected (discharged) by other methods. Examples of such other methods include a spray dry method, the so-called Bubble Jet method (“Bubble Jet” is a trademark) and a method disclosed in Japanese Patent Application No. 2002-321889, and the like. In the method disclosed in the Japanese Patent Application, a dispersion liquid is ejected in the form of droplets using a specific nozzle in which a dispersion liquid is transformed into a thin laminar flow by thinly expanding the dispersion liquid by forcing it onto a smooth flat surface using a gas flow, and then separating the thin laminar flow from the flat smooth surface to eject it in the form of droplets. The spray dry method is a method which obtains droplets by ejecting (spraying) a liquid (a dispersion liquid) using high pressure gas. Further, as an example of a method using the Bubble Jet method (“Bubble Jet” is a trademark), a method disclosed in Japanese Patent Application No. 2002-169348 and the like can be mentioned. Namely, the dispersion liquid may be ejected (discharged) by a method in which a dispersion liquid is intermittently ejected from a head portion using a volume change of gas.

Moreover, formation of the dry fine particles may be carried out without using the ejection of the dispersion liquid (water-based suspension). For example, it is possible to obtain dry fine particles by filtering the water-based suspension to filter out fine particles corresponding to a dispersoid.

Moreover, in the above embodiments, dry fine particles each having shape and size corresponding to each particle of the dispersoid contained in the water-based suspension is obtained. However, the dry fine particles of the present invention may be formed from aggregates which are formed by aggregating (or bonding) a plurality of particles of a dispersoid contained in the water-based suspension.

Moreover, in the above embodiments, a water-based emulsion is prepared using ground particles obtained by grinding the kneaded material, but such a grinding step of the kneaded material may be omitted.

Moreover, a method for preparing the water-based emulsion and the water-based suspension is not limited to the method described above. For example, it is possible to obtain a water-based emulsion by heating a dispersion liquid in which a solid state dispersoid is dispersed to transform the dispersoid into a liquid state, and then by cooling the water-based to obtain a water-based suspension.

Moreover, in the embodiments described above, once after a water-based suspension is obtained using a water-based emulsion, dry fine particles are produced using the water-based suspension. However, the dry fine particles may be produced directly from the water-based emulsion without using the water-based suspension. For example, it is possible to obtain dry fine particles by ejecting the water-based emulsion in the form of droplets, and then removing the dispersion medium together with the solvent contained in the dispersoid from the droplets.

(1) Production of Liquid Developer

### EXAMPLE 1

First, 80 parts by weight of an epoxy resin (softening point thereof was 80.5° C.) as a binder resin, 20 parts by weight of a cyanine pigment (“Pigment Blue 15:3”, manufactured by Dainichiseika Color & Chemicals Mfg. Co., Ltd.) as a coloring agent were prepared.

These components were mixed using a 20 L type Henschel mixer to obtain a material for producing toner particles.

Next, the material (mixture) was kneaded using a biaxial kneader-extruder shown in FIG. 1. The entire length of a process section of the biaxial kneader-extruder was 160 cm. Further, the material temperature in the process section was set to be 105 to 115° C. Furthermore, the rotational speed of the screw was 120 rpm, and the speed for feeding the material into the kneader-extruder was 20 kg/hour.

Under these conditions, a time required for the material to pass through the process section was about four minutes.

The kneading was carried out with deairing the inside of the process section by driving a vacuum pump connected to the process section through a deairing port.

The material (kneaded material) kneaded in the process section was extruded outside the biaxial kneader-extruder from the head portion. The temperature of the kneaded material at the head portion was adjusted to be 135° C.

The kneaded material extruded from the extruding port of the biaxial kneader-extruder was cooled by a cooling machine as shown in FIG. 1. The temperature of the kneaded material just after the cooling process was about 45° C.

The cooling rate of the kneaded material was −9° C./sec. Further, the time required for the completion of the cooling process from the end of the kneading process was 10 seconds.

The kneaded material cooled as described above was coarsely ground using a hammer mil to be formed into powder having an average particle size of 1.5 mm.

Next, 250 parts by weight of toluene was added to 100 parts by weight of the coarse kneaded material, and then it was subjected to a treatment using an ultrasound homogenizer (output: 400 μA) for one hour to obtain a solution in which the epoxy resin of the kneaded material was dissolved. In the solution, the pigment was finely dispersed homogeneously.

Further, 1 part by weight of sodium-dodecylbenzenesulfonic acid as a dispersant was mixed with 700 parts by weight of ion-exchanged water to obtain a water-based liquid.

The water-based liquid was stirred with a homomixer (PRIMIX Corporation) with the number of stirring being adjusted.

The above-mentioned solution (that is, the toluene solution of the kneaded material) was dropped in the water-based liquid which is being stirred, to obtain a water-based emulsion in which a dispersoid comprised of particles having an average particle size of 3 μm was homogeneously dispersed.

Thereafter, the toluene in the water-based emulsion was removed under the conditions in which a temperature was 100° C. and an ambience pressure was 80 kPa, and then it was cooled to a room temperature. Then, a predetermined amount of water was added thereto so that the concentration was adjusted to thereby obtain a water-based suspension in which solid fine particles are dispersed. In the thus obtained water-based suspension, substantially no toluene remains. The concentration of the solid component (dispersoid) of the thus obtained water-based suspension was 28.8 wt %. Further, the average particle size of the particles of the dispersoid (solid fine particles) dispersed in the suspension was 1.2 μm. The measurement of the average particle size was carried out using a laser diffraction/scattering type particle size distribution measurement apparatus (“LA-920” which is a product name of HORIBA Ltd.).

The thus obtained suspension was put into a water-based suspension supply section of a dry fine particle production apparatus shown in FIG. 2 and 3. The water-based suspension in the water-based suspension supply section was being stirred with a stirring means, and it was supplied to head portions by a metering pump so the suspension was ejected (discharged) to a dispersion medium removal section through ejection portions. Each ejection portion was a circular opening having a diameter of 25 μm. The head portions were of the type that a hydrophobic treatment was made around the ejection portions thereof with a fluorine resin (polytetrafluoroethylene) coating. Further, the temperature of the water-based suspension in the water-based suspension supply section was adjusted to be 25° C.

The ejection of the water-based suspension was carried out under the conditions that the temperature of the dispersion liquid in the head portions was 25° C., the frequency of vibration of each piezoelectric element was 10 kHz, the initial velocity of the dispersion liquid ejected from the ejection portions was 3 m/sec, and the size of one droplet ejected from each head portion was 4 pl (the diameter thereof was 20.8 μm). Further, the ejection of the water-based suspension was carried out so that the ejection timing of the water-based suspension was changed at least in the adjacent head portions in the plural head portions.

Further, when the water-based suspension was ejected, air was also ejected from the gas injection openings downwardly in a vertical direction, wherein the temperature of the air was 25° C., the humidity of the air was 27% RH, and the flow rate of the air was 3 m/sec. Further, the temperature of the inside of the housing (that is, the ambient temperature) was set to be 45° C., the pressure of the inside of the housing was about 1.5 kPa, and the length of the dispersion medium removal section (in the direction of conveying the dispersoid) was 1.0 m.

Furthermore, a voltage was applied to a part of the housing which constitutes the dispersion medium removal section so that an electrical potential at the side of the inner surface thereof was −200 V, thereby preventing the water-based suspension (dry fine particles) from being adhered to the inner surface of the housing.

Then, the dispersion medium was removed from the ejected water-based suspension in the dispersion medium removal section to thereby obtain dry fine particles (toner particles) each having shape and size corresponding to each particle of the dispersoid.

Thereafter, the dry fine particles formed in the dispersion medium removal section were collected at the cyclone. The water content of the collected dry fine particles was 0.56 wt %.

The collected dry fine particles were dispersed in a high insulation liquid to thereby obtain a liquid developer. As the high insulation liquid, a mixture of 360 parts by weight of ISOPAR H (Exson-Mobile Corporation) and 1 part by weight of surfactant (dodecyltrimethylammonium chloride) was used. The electrical resistance of the high insulation liquid at room temperature (20° C.) was 1.5×10¹⁵ Ωcm and the dielectric constant of the high insulation liquid was 2.2.

### EXAMPLES 2 TO 4

In each of Examples 2 to 4, a liquid developer was prepared in the same manner as in the Example 1 excepting that the average particle size of the particles of the dispersoid and the amount thereof were changed as shown in Table 1 by changing the amount of toluene in preparing the toluene solution of the kneaded material, the stirring condition of the water-based liquid in preparing the water-based emulsion, and the rate of dropping the solution, respectively.

### EXAMPLE 5

A liquid developer was prepared in the same manner as in Example 1 excepting that a polyester resin (softening point thereof was 125° C.) was used as a binder resin in preparing the kneaded material.

### COMPARATIVE EXAMPLE 1

A liquid developer was prepared in the same manner as in Example 1 excepting that a mixture of 80 parts by weight of an epoxy resin (softening point thereof was 80.5° C.) and 20 parts by weight of a oyanogen-based pigment (“Pigment Blue 15:3”, manufactured by Dainichiseika Color & Chemicals Mfg. Co., Ltd.) was used in preparing the emulsion instead of a kneaded material.

### COMPARATIVE EXAMPLE 2

First, in the same manner as Example 1, a coarsely ground kneaded material having an average particle size of 1.5 mm was obtained.

Then, the coarsely ground kneaded material was finely ground by a jet mill to thereby obtain fine particles having an average particle size of 3.1 μm.

Then, the thus obtained fine particles were dispersed in a mixture of 360 parts by weight of ISOPAR H (Exson-Mobile Corporation) and 1 part by weight of surfactant (dodecyltrimethylammonium chloride) to thereby obtain a liquid developer.

### COMPARATIVE EXAMPLE 3

A mixed solution comprised of 100 g of octadecylmethacrylate, 150 g of toluene. and 50 g of isopropanol was heated to a temperature of 75° C. with being stirred in a nitrogen gas stream. Then, 30 g of 2,2′-azobis (4-cyanovaleric acid) was added thereto to make reaction for eight hours, and after being cooled, it was settled out in 2 liter of methanol so that white powder was aggregated and then it was dried. Then, a mixture comprised of 50 g of the thus obtained white powder, 3.3 g of vinyl acetate, 0.2 g of hydroquinone, and 100 g of toluene was heated to a temperature of 40° C. to make reaction for 2 hours. Then, it was heated to 70° C. and 3.8×10⁻³ml of 100% sulfuric acid was added thereto to made reaction for 10 hours. Thereafter, it was cooled to a temperature of 25° C., and 0.02 g of sodium acetate trihydrate was added thereto. Thereafter, it was stirred for 30 minutes, and then it was settled out in 1 liter of methanol to aggregate, and then it was dried, to thereby obtain a resin for stabilizing dispersion.

Next, a mixed solution comprised of 12 g of the resin for stabilizing dispersion, 100 g of vinyl acetate, 1.0 g of octadecylmethacrylate, 384 g of ISOPAR H was heated to a temperature of 70° C. with being stirred in a nitride gas stream. Then, 0.8 g of 2,2-azobis (isovalernitryl) was added to make reaction for 6 hours. After 20 minutes of addition of an initiator, white turbidity was caused, and then the reaction temperature was raised to 88° C. Thereafter, the temperature was raised to 100° C., and then it was being stirred for 2 hours to distil away the unreacted vinyl acetate. After being cooled, it was passed through a nylon mesh of 200 meshes to thereby obtain white latex particles. The average particle size of the particles was 0.26 μm.

Next, 10 g of a copolymer of dodecylmethacrylate/acrylic acid, 10 g of nigrosine, and 30 g of ISOPAR G were put in a paint shaker (manufactured by Tokyo Seiki Co., Ltd.) together with glass beads, and then dispersion was being continued for 4 hours to thereby obtain fine dispersed substances of nigrosine.

Next, 30 g of the white latex particles, 2.5 g of the dispersed substances of nigrosine, and 0.07 g of a copolymer of octadecene/maleate octadecylamide were diluted with 1 liter of ISOPAR G, to thereby obtain a liquid developer.

The conditions for producing the liquid developers of the Examples and the Comparative Examples are shown in the following Table 1.

TABLE 1

| | | | Water-based | | Water-based | |
|---|---|---|---|---|---|---|
| | | | emulsion | | suspension | |
| | Binder resin | | Average | | Average | |
| | | Softening | diameter of | Amount of | diameter of | Amount of |
| | | point | Dispersoid | dispersoid | Dispersoid | dispersoid |
| | Kind of resin | [° C.] | [μm] | [wt %] | [μm] | [wt %] |
| Example 1 | Epoxy resin | 80.5 | 3.0 | 28.5 | 1.2 | 28.8 |
| Example 2 | Epoxy resin | 80.5 | 5.8 | 30.0 | 4.1 | 27.6 |
| Example 3 | Epoxy resin | 80.5 | 0.22 | 28.9 | 0.16 | 28.4 |
| Example 4 | Epoxy resin | 80.5 | 0.27 | 20.5 | 3.8 | 25.5 |
| Example 5 | Polyester | 125 | 3.2 | 30.0 | 1.5 | 29.0 |
| | resin | | | | | |
| Comp. Ex. 1 | Epoxy resin | 80.5 | 2.7 | 28.5 | 1.1 | 28.0 |
| Comp. Ex. 2 | Epoxy resin | 80.5 | — | — | — | — |
| Comp. Ex. 3 | Epoxy resin | 80.5 | — | — | — | — |

(2) Evaluation

For the respective liquid developers obtained as described above, image density, resolution, and storage stability were evaluated.

(2.1) Image Density

By using the image forming apparatus shown in FIG. 4 and the fixing unit shown in FIG. 6, images having a predetermined pattern were formed on recording papers employing the liquid developers of the Examples and the Comparative Examples, respectively, and then the image density of each recording paper was measured by a calorimeter (X-Rite Incorporated).

(2.2) Resolution

By using the image forming apparatus shown in FIG. 4 and the fixing unit shown in FIG. 6, images having a predetermined pattern were formed on recording papers employing the liquid developers of the Examples and the Comparative Examples, respectively, and then resolution of each image was observed with naked eyes.

(2.3) Storage Stability

The liquid developers obtained in the Examples and the Comparative Examples were being placed under the atmosphere of which temperature was in the range of 15 to 25° C. Thereafter, the toner particles in the liquid developers were observed with naked eyes, and the observation results were evaluated by the following four criteria.

A; Suspension of toner particles and aggregation and settling of toner particles were not observed at all.

B: Suspension of toner particles and aggregation and settling of toner particles were scarcely observed.

C: Suspension of toner particles and aggregation and settling of toner particles were slightly observed.

D: Suspension of toner particles and aggregation and settling of toner particles were clearly observed.

These results are shown in the following Table 2 together with the average roundness R, the standard deviation in the roundness, the average particle size per a predetermined number of particles, and the standard deviation in the particle size of the toner particles. In this connection, it is to be noted that the roundness R was measured by the use of a flow system particle image analyzer (FPIA-2000, manufactured by SYSMEX CORPORATION). The roundness R was determined by the following formula (I):
R=L₀/L₁ (I)

where L₁ (μm) represents the circumference of projected image of a particle that is a subject of measurement, and L₀ (μm) represents the circumference of a perfect circle having the same area as that of the projected image of the particle that is a subject of measurement.

TABLE 2

| | Shape of toner particle | | | | | | |
|---|---|---|---|---|---|---|---|
| | | | | Standard | | | |
| | | Standard | | deviation of | Evaluation | | |
| | | deviation of | Average | average | | Resolution | |
| | Average | average | diameter | diameter | Image | [line | Storage |
| | roundness R | roundness | [μm] | [μm] | density | paires/mm] | stability |
| Example 1 | 0.97 | 0.015 | 1.1 | 0.88 | 1.47 | 7.1 | A |
| Example 2 | 0.92 | 0.085 | 3.9 | 1.36 | 1.36 | 6.3 | B |
| Example 3 | 0.94 | 0.075 | 0.15 | 0.55 | 1.27 | 7.1 | B |
| Example 4 | 0.97 | 0.020 | 3.8 | 1.26 | 1.42 | 6.3 | B |
| Example 5 | 0.98 | 0.020 | 1.4 | 0.90 | 1.38 | 7.1 | B |
| Comp. Ex. 1 | 0.96 | 0.156 | 1.1 | 3.11 | 1.16 | 6.3 | C |
| Comp. Ex. 2 | 0.84 | 0.175 | 3.1 | 3.01 | 1.08 | 5.0 | D |
| Comp. Ex. 3 | 0.91 | 0.115 | 0.26 | 3.05 | 1.11 | 6.3 | D |

As shown in Table 2, in the liquid developers of the present invention, the roundness of the toner particles was large and the particle size distribution was small. Further, the toner particles had small variations in shape and size thereof (that is, the standard deviation of the roundness was small).

In contrast, in the liquid developers of the Comparative Examples, the toner particles had large variations in shape and size thereof. Further, in the liquid developers of the Comparative Examples, the toner particles had the unstable shapes, and the roundness thereof was low.

Further, as shown in Table 2, the liquid developers of the present invention had excellent image density, excellent resolution, and excellent storage stability. In contrast, in the liquid developers of the Comparative Examples, satisfactory results could not be obtained.

Furthermore, liquid developers which are the same as those described above were produced excepting that as a coloring agent a pigment red 122, pigment yellow 180, and a carbon black (“Printex L” Degussa AG) were used instead of a cyanogen-based pigment, and they were evaluated in the same manner as described above. As a result, substantially the same results could be obtained.

Moreover, liquid developers which are the same as those described above were produced using a different dry fine particle production apparatus in which the structure of the head portions was changed from the structure shown in FIG. 3 to the structure shown in each of FIGS. 7 to 10. As a result, substantially the same results could be obtained. Further, the dry fine particle production apparatuses shown in FIGS. 7 to 10 could appropriately eject dispersion liquids having relatively high viscosity (dispersion liquid having high content of dispersoid).

(3) Production of Liquid Developer

### EXAMPLE 6

First, 80 parts by weight of a styrene resin (softening point thereof was 75° C.) which is a self-dispersible type resin having a side chain of a —SO₃⁻ group) (sulfone acid Na group), 20 parts by weight of a cyanine pigment (“Pigment Blue 15:3”, manufactured by Dainichiseika Color & Chemicals Mfg. Co., Ltd.) as a coloring agent were prepared. The self-dispersible type resin contains 0.1 mole of a —SO₃⁻ group in 100 g of the self-dispersible type resin.

These components were mixed using a 20L type Henschel mixer to obtain a material for producing toner particles.

Next, the material (mixture) was kneaded using a biaxial kneader-extruder shown in FIG. 1. The entire length of a process section of the biaxial kneader-extruder was 160 cm. Further, the material temperature in the process section was set to be 125 to 135° C. Furthermore, the rotational speed of the screw was 120 rpm, and the speed for feeding the material into the kneader-extruder was 20 kg/hour.

Under these conditions, a time required for the material to pass through the process section was about 4 minutes.

The kneading was carried out with deairing the inside of the process section by driving a vacuum pump connected to the process section through a deairing port.

The material (kneaded material) kneaded in the process section was extruded outside the biaxial kneader-extruder from the head portion. The temperature of the kneaded material at the head portion was adjusted to be 130° C.

The kneaded material extruded from the extruding port of the biaxial kneader-extruder was cooled by a cooling machine as shown in FIG. 1. The temperature of the kneaded material just after the cooling process was about 40° C.

The cooling rate of the kneaded material was −9° C./sec. Further, the time required for the completion of the cooling process from the end of the kneading process was 10 seconds.

The kneaded material cooled as described above was coarsely ground using a hammer mil to be formed into powder having an average particle size of 1.5 mm.

Next, 250 parts by weight of toluene was added to 100 parts by weight of the coarse kneaded material, and then it was subjected to a treatment using an ultrasound homogenizer (output: 400 μA) for 1 hour to obtain a solution in which the self-dispersible type resin of the kneaded material was dissolved. In the solution, the pigment was finely dispersed homogeneously.

Further, a water-based liquid comprised of 700 parts by weight of ion-exchanged water was prepared.

The water-based liquid was stirred with a homomixer (PRIMIX Corporation) with the number of stirring being adjusted.

The above-mentioned solution (that is, the toluene solution of the kneaded material) was dropped in the water-based liquid which is being stirred, to obtain a water-based emulsion in which a dispersoid comprised of particles having an average particle size of 3 μm was homogeneously dispersed.

Thereafter, the toluene in the water-based emulsion was removed under the conditions in which a temperature was 100° C. and an ambience pressure was 80 kPa, and then it was cooled to a room temperature to thereby obtain a water-based suspension in which solid fine particles were dispersed. In the thus obtained water-based suspension, substantially no toluene remains. The concentration of the solid component (dispersoid) of the thus obtained water-based suspension was 25.0 wt %. Further, the average particle size of the particles of the dispersoid (solid fine particles) dispersed in the suspension was 1.8 μm. The measurement of the average particle size was carried out using a laser diffraction/scattering type particle size distribution measurement apparatus (“LA-920” a product name of HORIBA Ltd.).

The thus obtained suspension was put into a water-based suspension supply section of a dry fine particle production apparatus shown in FIG. 2 and 3. The water-based suspension in the water-based suspension supply section was being stirred with a stirring means, and it was supplied to head portions by a metering pump so the suspension was ejected (discharged) to a dispersion medium removal section through ejection portions. Each ejection portion was a circular opening having a diameter of 25 μm. The head portions were of the type that a hydrophobic treatment was made around the ejection portions thereof with a fluorine resin (polytetrafluoroethylene) coating. Further, the temperature of the water-based suspension in the water-based suspension supply section was adjusted to be 25° C.

The ejection of the water-based suspension was carried out under the conditions that the temperature of the dispersion liquid in the head portions was 25° C., the frequency of vibration of each piezoelectric element was 10 kHz, the initial velocity of the dispersion liquid ejected from the ejection portions was 3 m/sec, and the size of one droplet ejected from each head portion was 4 pl (the diameter thereof was 20.8 μm). Further, the ejection of the water-based suspension was carried out so that the ejection timing of the water-based suspension was changed at least in the adjacent head portions in the plural head portions.

Further, when the water-based suspension was ejected, air was also ejected from the gas injection openings downwardly in a vertical direction, wherein the temperature of the air was 25° C., the humidity of the air was 27% RH, and the flow rate of the air was 3 m/sec. Further, the temperature of the inside of the housing (that is, the ambient temperature) was set to be 45° C., the pressure of the inside of the housing was about 1.5 kPa, and the length of the dispersion medium removal section (in the direction of conveying the dispersoid) was 1.0 m.

Furthermore, a voltage was applied to a part of the housing which constitutes the dispersion medium removal section so that an electrical potential at the side of the inner surface thereof was −200 V, thereby preventing the water-based suspension (dry fine particles) from being adhered to the inner surface of the housing.

Then, the dispersion medium was removed from the ejected water-based suspension in the dispersion medium removal section to thereby obtain dry fine particles (toner particles) each having shape and size corresponding to each particle of the dispersoid.

Thereafter, the dry fine particles formed in the dispersion medium removal section was collected at the cyclone. The water content of the collected dry fine particles was 0.42 wt %.

The collected dry fine particles were dispersed in a high insulation liquid to thereby obtain a liquid developer. As the high insulation liquid, a mixture of 360 parts by weight of ISOPAR H (Exson-Mobile Corporation) and 1 part by weight of surfactant (dodecyltrimethylammonium chloride) was used. The electrical resistance of the high insulation liquid at room temperature (20° C.) was 1.5×10¹⁵ Ωcm and the dielectric constant of the high insulation liquid was 2.2.

### EXAMPLES 7 TO 9

In each of Examples 7 to 9, a liquid developer was prepared in the same manner as in the Example 6 excepting that the average particle size of the particles of the dispersoid and the amount thereof were changed as shown in Table 3 by changing the amount of toluene in preparing the toluene solution of the kneaded material, the stirring condition of the water-based liquid in preparing the water-based emulsion, and the rate of dropping the solution, respectively.

### EXAMPLE 10

A liquid developer was prepared in the same manner as in Example 6 excepting that a styrene resin having a side chain of —PO₄⁻ group (softening point thereof was 105° C.) was used as a self-dispersible type resin in preparing the kneaded material. The self-dispersible type resin had 0.1 mol of —PO₄⁻ group in the 100 g of self-dispersible type resin.

### COMPARATIVE EXAMPLE 4

A liquid developer was prepared in the same manner as in Example 6 excepting that a mixture of 80 parts by weight of a styrene resin (the same resin as that used in the Example 6) and 20 parts by weight of a cyanogen-based pigment (“Pigment Blue 15:3”, manufactured by Dainichiseika Color & Chemicals Mfg. Co., Ltd.) was used in preparing the emulsion instead of a kneaded material.

### COMPARATIVE EXAMPLE 5

First, in the same manner as Example 6, a coarsely ground kneaded material having an average particle size of 1.5 mm was obtained.

Then, the coarsely ground kneaded material was finely ground by a jet mill to thereby obtain fine particles having an average particle size of 3.5 μm.

Then, the thus obtained fine particles were dispersed in a high insulation liquid ISOPAR H (Exson-Mobile Corporation) to thereby obtain a liquid developer. The electric resistance of the high insulation liquid at room temperature was 5×10¹⁵ Ωcm and the dielectric constant of the high insulation liquid was 2.2.

### COMPARATIVE EXAMPLE 6

A mixed solution comprised of 100 g of octadecylmethacrylate, 150 g of toluene, and 50 g of isopropanol was heated to a temperature of 75° C. with being stirred in a nitrogen gas stream. Then, 3.0 g of 2,2′-azobis (4-cyanovaleric acid) was added thereto to make reaction for 8 hours, and after being cooled, it was settled out in 2 liter of methanol so that white powder was aggregated and then it was dried. Then, a mixture comprised of 50 g of the thus obtained white powder, 3.3 g of vinyl acetate, 0.2 g of hydroquinone, and 100 g of toluene was heated to a temperature of 40° C. to make reaction for 2 hours. Then, it was heated to 70° C. and 3.8×10⁻³ml of 100% sulfuric acid was added thereto to made reaction for 10 hours. Thereafter, it was cooled to a temperature of 25° C., and 0.02 g of sodium acetate trihyddrate was added thereto. Thereafter, it was stirred for 30 minutes, and then it was settled out in 1 liter of methanol to aggregate, and then it was dried, to thereby obtain a resin for stabilizing dispersion.

Next, a mixed solution comprised of 12 g of the resin for stabilizing dispersion, 100 g of vinyl acetate, 1.0 g of octadecylmethacrylate, 384 g of ISOPAR H was heated to a temperature of 70° C. with being stirred in a nitride gas stream. Then, 0.8 g of 2,2-azobis (isovalernitryl) was added to make reaction for 6 hours. After 20 minutes of addition of an initiator, white turbidity was caused, and then the reaction temperature was raised to 88° C. Thereafter, the temperature was raised to 100° C., and then it was being stirred for 2 hours to distil away the unreacted vinyl acetate. After being cooled, it was passed through a nylon mesh of 200 meshes to thereby obtain white latex particles. The average particle size of the particles was 0.26 μm.

Next, 10 g of a copolymer of dodecylmethacrylate/acrylic acid, 10 g of nigrosine, and 30 g of ISOPAR G were put in a paint shaker (Tokyo Seiki Co., Ltd.) together with glass beads, and then dispersion was being continued for 4 hours to thereby obtain fine dispersed substances of nigrosine.

Next, 30 g of the white latex particles, 2.5 g of the dispersed substances of nigrosine, and 0.07 g of a copolymer of octadecene/maleate octadecylamide were diluted with 1 liter of ISOPAR G, to thereby obtain a liquid developer.

### REFERENCE EXAMPLE

The inventors have attempted to prepare a water-based suspension in the same manner as in Example 6 excepting that a styrene resin having no hydrophilic functional group in molecular (softening point was 120° C.) was used instead of the self-dispersible resin in preparation of the kneaded material. However, it was not possible to obtain a dispersion liquid in which fine particles constituted from the styrene resin were dispersed. Namely, it was not possible to obtain such a water-based suspension. Therefore, in this reference example, a liquid developer could not be produced. In this regard, please note that in the case where a dispersant was used in the same manner as the Examples 6 to 10, a water-based suspension could be obtained, and a liquid developer could also be produced using the water-based suspension.

The conditions for producing the liquid developers of the Examples 6 to 10, the Comparative Examples 4 to 6 and the Reference Example are shown in the following Table 3. In the table, the evaluation concerning the ejection stability of the droplets of the dispersion liquid was made as follows. Namely, in the case where droplets having a uniform size (variations in the average particle size was 5% or less) could be ejected stably for a long period of time (more than 6 hours), “Good” evaluation was made, and in the case where variations in the size of the ejected droplets became drastically large (variations in the average particle size was 5% or more) within 3 hours from the start of the ejection of the dispersion liquid, “Poor” evaluation was made.

TABLE 3

| | | | Water-based | | Water-based | | |
|---|---|---|---|---|---|---|---|
| | | | emulsion | | suspension | | |
| | Binder resin | | Average | | Average | | |
| | | Softening | diameter of | Amount of | diameter of | Amount of | Ejection |
| | Hydrophilic | point | Dispersoid | dispersoid | Dispersoid | dispersoid | stability of |
| | group | [° C.] | [μm] | [wt %] | [μm] | [wt %] | droplets |
| Example 6 | —COO⁻group | 75 | 3 | 33.3 | 1.8 | 25 | Good |
| Example 7 | —COO⁻group | 75 | 4.5 | 33.3 | 4.0 | 25 | Good |
| Example 8 | —COO⁻group | 75 | 2.5 | 33.3 | 2.1 | 25 | Good |
| Example 9 | —COO⁻group | 75 | 3 | 22.0 | 2.3 | 15 | Good |
| Example 10 | —PO₄⁻group | 105 | 2.8 | 33.3 | 1.6 | 25 | Good |
| Comp. Ex. 4 | —COO⁻group | 75 | 3.0 | 33.3 | 2.0 | 25 | Poor |
| Comp. Ex. 5 | —COO⁻group | 75 | — | — | — | — | Poor |
| Comp. Ex. 6 | —COO⁻group | 75 | — | — | — | — | Poor |

As shown in Table 3, in the present invention ejection of droplets could be carried out stably, while in the Comparative Examples 4 to 6, ejection of droplets could not be carried out stably.

s(4) Evaluation

For the respective liquid developers obtained as described above, image density, resolution, and storage stability were evaluated.

(4.1) Image Density

By using the image forming apparatus shown in FIG. 4 and the fixing unit shown in FIG. 6, images having a predetermined pattern were formed on recording papers employing the liquid developers of the Examples and the Comparative Examples, respectively, and then the image density of each recording paper was measured by a calorimeter (X-Rite Incorporated).

(4.2) Resolution

By using the image forming apparatus shown in FIG. 4 and the fixing unit shown in FIG. 6, images having a predetermined pattern were formed on recording papers employing the liquid developers of the Examples and the Comparative Examples, respectively, and then resolution of each image was observed with naked eyes.

(4.3) Storage Stability

The liquid developers obtained in the Examples and the Comparative Examples were being placed under the atmosphere of which temperature was in the range of 15 to 25° C. Thereafter, the toner particles in the liquid developers were observed with naked eyes, and the observation results were evaluated by the following four criteria.

A: Suspension of toner particles and aggregation and settling of toner particles were not observed at all.

B: Suspension of toner particles and aggregation and settling of toner particles were scarcely observed.

C: Suspension of toner particles and aggregation and settling of toner particles were slightly observed.

D: Suspension of toner particles and aggregation and settling of toner particles were clearly observed.

These results are shown in the following Table 4 together with the average roundness R, the standard deviation in the roundness, the average particle size per a predetermined number of particles, and the standard deviation in the particle size of the toner particles. In this connection, it is to be noted that the roundness was measured by the use of a flow system particle image analyzer (FPIA-2000, manufactured by Toa Iyodensi Co.). The roundness R was determined by the following formula (I):
R=L₀/L₁ (I)

where L₁ (μm) represents the circumference of projected image of a particle that is a subject of measurement, and L₀ (μm) represents the circumference of a perfect circle having the same area as that of the projected image of the particle that is a subject of measurement.

TABLE 4

| | | | | Standard | Water | | | |
|---|---|---|---|---|---|---|---|---|
| | | Standard | | deviation of | content of | Evaluation | | |
| | | deviation of | Average | average | toner | | Resolution | |
| | Average | average | diameter | diameter | particle | Image | [line | Storage |
| | roundness R | roundness | [μm] | [μm] | [wt %] | density | paires/mm] | stability |
| Example 6 | 0.985 | 0.015 | 1.7 | 0.88 | 0.42 | 1.48 | 7.1 | A |
| Example 7 | 0.960 | 0.011 | 3.9 | 1.24 | 0.38 | 1.36 | 6.3 | B |
| Example 8 | 0.955 | 0.020 | 1.9 | 1.18 | 0.40 | 1.32 | 6.3 | B |
| Example 9 | 0.970 | 0.022 | 2.2 | 1.15 | 0.41 | 1.33 | 6.3 | B |
| Example 10 | 0.980 | 0.018 | 1.6 | 0.98 | 0.66 | 1.35 | 7.1 | A |
| Comp. Ex. 4 | 0.925 | 0.080 | 1.9 | 1.36 | 0.55 | 1.21 | 5.0 | C |
| Comp. Ex. 5 | 0.848 | 0.160 | 3.3 | 3.11 | 0.45 | 1.16 | 5.0 | D |
| Comp. Ex. 6 | 0.910 | 0.115 | 0.26 | 3.05 | 0.48 | 1.11 | 6.3 | D |

As shown in Table 4, in the liquid developers of the present invention, the roundness of the toner particles was large and the particle size distribution was small. Further, the toner particles had small variations in shape and size thereof (that is, the standard deviation of the roundness was small).

In contrast, in the liquid developers of the Comparative Examples, the toner particles had large variations in shape and size thereof. Further, in the liquid developers of the Comparative Examples, the toner particles had the unstable shapes, and the roundness thereof was low.

Further, as shown in Table 4, the liquid developers of the present invention had excellent image density, excellent resolution, and excellent storage stability. In contrast, in the liquid developers of the Comparative Examples, satisfactory results could not be obtained.

Furthermore, liquid developers which are the same as those described above were produced excepting that as a coloring agent a pigment red 122, pigment yellow 180, and a carbon black (“Printex L” Degussa AG) were used instead of a cyanogen-based pigment, and they were evaluated in the same manner as described above. As a result, substantially the same results could be obtained.

Moreover, liquid developers which are the same as those described above were produced using a different dry fine particle production apparatus in which the structure of the head portions was changed from the structure shown in FIG. 3 to the structure shown in each of FIGS. 7 to 10. As a result, substantially the same results could be obtained. Further, the dry fine particle production apparatuses shown in FIGS. 7 to 10 could appropriately eject dispersion liquids having relatively high viscosity (dispersion liquid having high content of dispersoid).

Finally, it is to be noted that the present invention is not limited to the embodiments and the examples described above, and many additions and modifications may be made without departing from the spirit of the present invention which are defined by the following claims.

What is claimed is:

1. A method of producing a liquid developer which comprises a high insulation liquid and toner particles dispersed in the high insulation liquid, the method comprising the steps of:
a kneading step for kneading a material containing a pigment and a resin material to obtain a kneaded material;
a water-based emulsion preparing step for preparing a water-based emulsion, the water-based emulsion comprising a dispersoid composed of a material for the toner particles which has been prepared based on the kneading material and a water-based dispersion medium constituted from a water-based liquid in which the dispersoid is dispersed;
a dispersion medium removal step for removing the dispersion medium to obtain dry fine particles which are used as the toner particles; and
a dispersing step for dispersing the dry fine particles into the high Insulation liquid.

2. The method of producing a liquid developer as claimed in claim 1, wherein a self-dispersible type resin is used as the resin material.

3. The method of producing a liquid developer as claimed in claim 2, wherein the self-dispersible type resin contains a hydrophilic group in its molecular.

4. The method of producing a liquid developer as claimed in claim 3, wherein the hydrophilic group is a —COO³¹ group or —SO₃⁻ group.

5. The method of producing a liquid developer as claimed in claim 3, wherein the number of moles of the hydrophilic group contained in the self-dispersible type resin is 0.001 to 0.05 mol with respect to 100 g of the self-dispersible type resin.

6. The method of producing a liquid developer as claimed in claim 1, wherein an average particle size of the dispersoid contained in the water-based emulsion is in the range of 0.01 to 5 μm.

7. The method of producing a liquid developer as claimed in claim 1, wherein the kneading step is carried out at a temperature equal to or higher than the softening temperature of the resin material.

8. The method of producing a liquid developer as claimed in claim 1, wherein the water-based emulsion is prepared using a solution obtained by dissolving at least a part of the kneaded material into a solvent which can dissolve the kneaded material.

9. The method of producing a liquid developer as claimed in claim 8, wherein in the water-based dispersion medium removal step, a water-based suspension obtained by removing the solvent from the water-based emulsion is used.

10. The method of producing a liquid developer as claimed in claim 1, wherein a water-based suspension obtained by dispersing a solid state dispersoid into the water-based dispersion medium is prepared using the water-based emulsion, and then thus prepared water-based emulsion is used in the water-based dispersion medium removal step.

11. The method of producing a liquid developer as claimed in claim 9, wherein an average particle size of the dispersoid contained in the water-based suspension is in the range of 0.01 to 5 μm.

12. A liquid developer produced using the liquid developer producing method defined in claim 1.

13. The liquid developer as claimed in claim 12, wherein an average particle size of toner particles is in the range of 0.1 to 5 μm.

14. The liquid developer as claimed in claim 12, wherein the standard deviation in the particle sizes among the toner particles is 3.0 μm or less.

15. The liquid developer as claimed in claim 12, wherein an average value of the roundness R (average sphericity) of the toner particles represented by the following formula (I) is 0.85 or more:
R=L₀/L₁ (I)
wherein L₁ (μm) represents the circumference of a projected image of a toner particle, and L₀ (μm) represents the circumference of a perfect circle (a geometrically perfect (circle) having the same area as that of the projected image of the toner particle.

16. The liquid developer as claimed in claim 12, wherein the standard deviation in the average roundness of the toner particles is 0.15 or less.
